(19) United States
(12) Patent Application Publication
(10) Pub. No.: US 2026/0228023 A1
(43) Pub. Date: Aug. 6, 2026

(54) Systems and Methods for One-Click Root Cause Analysis

(71) Applicant: Cisco Technology, Inc., San Jose, CA (US)

(72) Inventors: Umang Agarwal, Menlo Park, CA (US); Akila Balasubramanian, Campbell, CA (US); Nasim Bigdelu, North Vancouver (CA); Kristal Curtis, San Francisco, CA (US); Liang Gou, San Jose, CA (US); Abhinav Mathur, Oakland, CA (US); Rehan Salman Mulla, Fremont, CA (US); Om Rajyaguru, San Diego, CA (US); Joseph Ari Ross, Redwood City, CA (US); Emily Yang, New York, NY (US)

(21) Appl. No.: 19/211,011

(22) Filed: May 16, 2025

Related U.S. Application Data
(60) Provisional application No. 63/753,407, filed on Feb. 3, 2025.

(51) Int. Cl. G06F 9/451; G06N 3/0895

(52) U.S. Cl. CPC G06F 9/451; G06N 3/0895

(57) ABSTRACT

One implementation is directed to implementations of an artificial intelligence (AI) assistant providing in a one-click root cause analysis (RCA). The disclosure provides for receiving a user input via a graphical user interface (GUI) requesting automated performance of a root cause analysis corresponding to an alert due to a triggering event, wherein the triggering event is associated with a time-series data set. A pre-processing may be performed on the time-series data set including performing an anomaly detection and retrieving one or more of traces or logs associated with the time-series data set. A prompt is generated instructing a large language model (LLM) to perform the root cause analysis based on results of the pre-processing and receiving a response to the prompt from the LLM including results of the root cause analysis. The GUI may be revised or updated to display of results of the root cause analysis.

### CROSS-REFERENCE TO RELATED APPLICATIONS

This application claims the benefit of priority to U.S. Provisional Application No. 63/753,407, filed on Feb. 3, 2025, the entire contents of which are incorporated herein by reference.

### FIELD

The present disclosure relates to artificial intelligence systems. More particularly, the present disclosure relates to root cause analysis.

### BACKGROUND

Large Language Models (LLMs) have progressed from early language-processing techniques to become sophisticated AI systems reshaping digital communication and content creation. The journey of LLMs started with basic natural language processing (NLP) research in the mid-20th century, but modern models emerged only recently, as advancements in deep learning and neural networks took center stage. The transformer architecture marked a turning point for LLMs, as it allowed models to capture complex dependencies and context in text efficiently. Since their inception, LLMs have pushed the boundaries of language understanding and generation. However, the success of these models also relies heavily on GPU capabilities, which enable the parallel processing required to handle the massive datasets and billions, or even trillions of parameters. GPUs can provide the speed and computational power that allow LLMs to perform real-time language tasks, even as they grow increasingly complex.

Industries are integrating LLMs in varied ways to streamline operations, boost creativity, and enhance productivity, with applications ranging from customer service to software development and healthcare. Advanced AI agents powered by LLMs are becoming common, allowing businesses to manage customer interactions through natural language understanding, where these agents can handle complex inquiries and generate detailed responses. In creative fields, LLM-based AI agents assist with drafting content, suggesting ideas, and even composing music or visual captions, enhancing creative processes by providing inspiration and augmenting human creativity. In software development, AI agents can automate parts of the coding process, generating code snippets, detecting bugs, and maintaining documentation. Healthcare is also benefiting from LLMs, as AI agents assist in summarizing medical records and offering preliminary diagnostic support. However, as LLMs and AI agents support these diverse applications, the demand on GPUs and network infrastructure grows considerably. To manage these increasing loads, organizations often rely on high-capacity Network Interface Cards (NICs) with load-balancing and flow control, such as Queue Pair (QP) capacity, to efficiently manage data flow and distribute tasks across clusters. This network infrastructure becomes essential for scaling up LLM-based agents to handle real-time interactions and large user bases without sacrificing responsiveness.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a diagram depicting various subsets of artificial intelligence in accordance with various embodiments of the disclosure;

FIG. 2 depicts different methods of machine-based learning in accordance with various embodiments of the disclosure;

FIG. 3 depicts a machine learning lifecycle in accordance with various embodiments of the disclosure; and

FIG. 4 is an exemplary neural network for use in a fully controlled camera system in accordance with various embodiments of the disclosure.

FIG. 5 is a conceptual illustration of a variety of tokens for utilization within a large language model in accordance with various embodiments of the disclosure;

FIG. 6 is a conceptual illustration of an embedding matrix for a large language model, in accordance with various embodiments of the disclosure;

FIG. 7 is a conceptual illustration of an input prompt converted from a series of tokens into a series of tensors in accordance with various embodiments of the disclosure;

FIG. 8 is a conceptual illustration of an attention layer process within a large language model in accordance with various embodiments of the disclosure;

FIG. 9 is a conceptual illustration of a multi-layer perceptron within a large language model in accordance with various embodiments of the disclosure;

FIG. 10 is a conceptual illustration of an unembedding process within a large language model in accordance with various embodiments of the disclosure;

FIG. 11 is an illustrative graphical user interface (GUI) alert pop-up window including a user interface (UI) component configured to receive user input to initiate an automated root cause analysis in accordance with various embodiments of the disclosure;

FIGS. 12A-12B provide an illustrative operational flow in the performance of an automated root cause analysis through deployment of a large language model (LLM) following receipt of user input to the GUI alert pop-up window such as that shown in FIG. 11 in accordance with various embodiments of the disclosure;

FIG. 13 is a conceptual illustration of performance of an automated root cause analysis through deployment of an artificial intelligence (AI) assistant that includes root cause analysis (RCA) logic, an orchestration agent, a plurality of sub-large language model (LLMs), and a plurality of logic modules in accordance with various embodiments of the disclosure;

FIG. 14 is a flowchart illustrating a first example process of operations for performing an automated root cause analysis according to an implementation of the disclosure;

FIG. 15 is a flowchart illustrating a second example process of operations for performing an automated root cause analysis according to an implementation of the disclosure;

FIG. 16 is a logical representation of a root cause analysis (RCA) logic in accordance with various embodiments of the disclosure;

FIGS. 17A-17B provide an illustrative operational flow in the performance of an automated root cause analysis through deployment of a large language model (LLM) following receipt of user input to a chat interface in accordance with various embodiments of the disclosure;

FIG. 18 provides an illustrative operational flow in the performance of an automated root cause analysis through deployment of a large language model (LLM) following receipt of user input to a chat interface including acquisition of context from a displayed webpage in accordance with various embodiments of the disclosure;

FIG. 19 is a block diagram showing a system employing the one-click root cause analyzer (RCA) in accordance with various embodiments of the disclosure;

FIG. 20 is a flow diagram showing an example sequence of functions of the one-click RCA in accordance with various embodiments of the disclosure;

FIG. 21 is a block diagram showing an example sequence of operations of the one-click RCA in accordance with various embodiments of the disclosure;

FIG. 22 is a flowchart illustrating a process of generating a one-click RCA in accordance with various embodiments of the disclosure;

FIG. 23 is a flowchart illustrating a process of assessing the triggering event in accordance with various embodiments of the disclosure;

FIG. 24 is a flowchart illustrating a process of inferring a root cause in accordance with various embodiments of the disclosure;

FIG. 25 is a flowchart illustrating a process of analyzing a historical record in accordance with various embodiments of the disclosure;

FIG. 26 is a flowchart illustrating a process of recommending an action in accordance with various embodiments of the disclosure;

FIG. 27 is a flowchart illustrating a process of compiling feedback data in accordance with various embodiments of the disclosure;

FIG. 28 is a diagram illustrating a one-click RCA using a rule-based system and/or a machine learning system in accordance with various embodiments of the disclosure;

FIG. 29 is a block diagram illustrating an example computing environment that includes a data intake and query system in accordance with various embodiments of the disclosure;

FIG. 30 is a block diagram illustrating in greater detail an example of an indexing system of a data intake and query system, such as the data intake and query system of FIG. 29 in accordance with various embodiments of the disclosure;

FIG. 31 is a block diagram illustrating in greater detail an example of the search system of a data intake and query system, such as the data intake and query system of FIG. 29 in accordance with various embodiments of the disclosure; and

FIG. 32 illustrates an example of a self-managed network 3200 that includes a data intake and query system in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to various issues described herein, devices and methods discussed herein provide for an SRv6-enabled AI scheduler that can offer an open-standard, vendor-neutral solution optimizing load distribution across network links, significantly enhancing cluster performance. These embodiments can include various uses within the AI field and can be utilized by various industries. Often, these methods, devices, and/or systems can incorporate one or more large language models (LLMs).

As those skilled in the art will recognize, Artificial Intelligence (AI) is a broad field within computer science focused on creating systems that can simulate aspects of human intelligence. These systems can range from simple rule-based programs to sophisticated models capable of learning, adapting, and making decisions based on data. AI spans various branches, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is becoming increasingly embedded in our daily lives, powering applications from personal assistants to autonomous vehicles and even aiding in scientific research and complex problem-solving.

Machine learning (ML) is a crucial subset of AI that involves systems learning from data to make predictions or decisions without being explicitly programmed for each task. Unlike traditional software, which relies on hard-coded rules, machine learning systems use algorithms that identify patterns and adjust their behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML serves as the foundation for many modern AI applications, as it enables systems to generalize from data and improve over time. As such, ML systems are central to the development of more advanced AI models and applications, including those that require nuanced understanding, like image recognition and language processing.

Large Language Models (LLMs) represent a specific application of machine learning within AI, focused on understanding and generating human language. Positioned within the broader field of natural language processing (NLP), LLMs utilize advanced machine learning architectures, particularly deep learning and transformer models, to process vast amounts of text data. Through this training, LLMs develop the ability to capture context, generate coherent responses, and perform complex language-based tasks, making them valuable tools in a range of applications, from chatbots to content creation and data analysis.

By processing vast amounts of text data, these LLMs can capture intricate patterns, nuances, and contextual relationships within language, allowing them to respond with relevance and a degree of fluency previously seen only in human communication. Broadly, LLMs work by breaking down text into tokens, converting them into vector representations, and using complex architectures with attention layers and multi-layer perceptrons to generate contextually appropriate responses. This process can enable the models to understand context, recall relevant information, and even produce creative or technical outputs based on learned knowledge. Their impact spans multiple industries. For example, they can support customer service, automate repetitive tasks, assist with brainstorming and writing, and even provide foundational support in software development and data analysis.

As those skilled in the art will recognize, the principles underlying LLMs can be generalized to other forms of AI models that handle diverse types of data, such as audio, visual, and even multimodal information. While LLMs are specialized for processing and generating language, similar architectures and concepts apply to Large Audio Models (LAMs), Large Vision Models (LVMs), and Large Foundation Models (LFMs) that incorporate multiple data types. These models operate on the same foundational ideas such as breaking down complex input (whether sounds, images, or mixed formats) into smaller, structured units, transforming these into numerical representations, and using layers of processing to capture relationships, context, and patterns within the data. Just as LLMs use tokens and embeddings for text, LAMs may segment and analyze audio signals, while LVMs and LFMs might extract features from images or combine textual and visual data for a richer, holistic understanding. This generalizable framework can enable AI to address tasks across different domains, making it possible to train models that understand, generate, and respond to varied data formats, whether in speech recognition, image analysis, or other complex, cross-functional applications. Consequently, the discussion of LLMs opens doors to understanding a broader landscape of AI technologies that share structural similarities yet target distinct types of information.

In many embodiments, the first stage in processing with an LLM can involve breaking down text into tokens, which are individual units that may represent words, subwords, or characters. This process, called tokenization, can assign each unique token a specific identifier, providing a standard format that the model can use to handle text more systematically. By transforming language input into a structured sequence of tokens, the model can gain a foundation that supports further transformations and simplifies working with complex text.

In more embodiments, the model may use an embedding matrix to convert each token into a dense vector, capturing its semantic meaning in numerical terms. The embedding matrix may hold a unique vector representation for each token, designed so that similar words or concepts can be positioned near each other in the model's multi-dimensional space. This approach can help the model achieve a form of conceptual understanding, where tokens with related meanings may be encoded in ways that reflect their relationships. By producing these vector representations, the model can start to develop a nuanced understanding of each token's role within a broader context.

With tokens now represented as vectors, the model can organize these vectors into an array that may hold the sequence of tokens from the original input text. This array can preserve the order of tokens, structuring them as a unified dataset for further processing. By arranging token information in this structured format, the model can prepare the data for a sequence of processing layers that may work to extract patterns and relationships within the data. Each vector within the array can carry information about a token's meaning and context, positioning the data for deeper levels of processing.

In further embodiments, an LLM can include one or more attention layers, which can enable the model to compare different parts of the input sequence and assess their contextual relevance. These attention layers may allow the model to assign varying levels of focus across tokens depending on the patterns it detects, highlighting words or phrases that can carry the most significance in a given context. By adjusting its focus across the sequence, the model can capture relationships between tokens that may not be apparent from isolated words. The attention mechanism can help the model build a detailed understanding, determining which parts of the input should influence the output most strongly.

Once these attention layers have established relationships within the input, the data may pass through one or more Multi-Layer Perceptrons (MLPs). In further embodiments, MLPs are fully connected neural networks that can refine the data further by identifying additional complex relationships and patterns. This stage may allow the model to distill its understanding of the input text, building on insights from the attention layers to develop an even more structured form of comprehension. The MLPs can support the model's ability to respond with greater relevance and coherence by transforming these contextual insights into a format ready for output.

Finally, in various embodiments, the refined data may reach an unembedding layer, where the model can translate its internal vector representations back into tokens. At this stage, the model can select the most probable next token based on the processed data, starting to generate a coherent output sequence. This transformation can allow the model to return from its internal numerical understanding to human-readable language, producing tokens that form a meaningful response. By iterating through these steps, the model can generate an output sequence that aligns with the context of the input, completing the journey from initial text input to comprehensible, contextually relevant output.

In specific embodiments described herein related to large-scale AI training clusters, data parallelism is a commonly adopted approach that allows multiple GPUs to operate in parallel on the same task across extensive datasets. This setup requires frequent synchronization of memory between GPUs, especially as training jobs may involve more than 15,000 iterations. After each iteration, GPUs must often communicate and exchange data, resulting in periodic, bursty flows.

Related to this are Queue Pairs (QPs) that are related to systems that rely on Remote Direct Memory Access (RDMA) for efficient data transfer. A QP can consist of two primary components, including a send queue and a receive queue. Together, these queues manage the flow of data between different nodes in a network, allowing one side to send data while the other receives it. In certain networking technologies, QPs enable direct memory access from one computer to another without involving the host CPU, greatly reducing latency and increasing data transfer speed. This is especially useful in distributed computing environments, where tasks like training machine learning models require the rapid exchange of large volumes of data across multiple machines.

Related to this, Network Interface Cards (NICs) include the hardware responsible for handling data transmission between nodes utilizing QPs. This can allow for greater parallelism and load balancing across network connections. This ability to handle numerous QPs simultaneously enables NICs to manage data flow effectively, distributing network traffic across multiple channels to optimize bandwidth and reduce bottlenecks. In distributed machine learning and AI applications, where large-scale models like LLMs may benefit from consistent, high-speed data exchange between processing units, NICs with QP capacity are desired. However, NICs have a finite capacity for QP flows, meaning they can only manage a limited number of simultaneous data streams, which restricts the number of connections or data transfers it can efficiently handle at once.

Currently, load-balancing mechanisms struggle with the large flows required by LLMs. Hash-based load balancing is particularly prone to issues like hash polarization, where specific flows are repeatedly directed through the same network paths, leading to congestion. This congestion results in significant delays in job completion times, impacting overall training efficiency and scaling. Addressing this challenge of hash polarization is essential to optimize network flow distribution and ensure that training clusters can operate at peak efficiency, minimizing delays and enabling faster AI model training. hash polarization is also problematic.

Additionally, the limited QP (i.e., flows) capacity of NICs presents a further constraint. For example, the NIC performance degrades when using more than a hundred QPs. This prevents breaking down these large flows into smaller, more manageable flows. As a result, the flow characteristics cannot be adjusted to reduce their impact on the network, necessitating a different approach to minimize congestion and polarization. Overcoming this constraint is desired for improving network efficiency in AI training environments and reducing job completion times. Finally, AI training clusters can often suffer from congestion and delays due to hash polarization in load balancing. Current solutions, including Differentiated Services Field (DSF) or User Datagram Protocol (UDP) port manipulation, have limitations in interoperability, adaptability to topology changes, and scalability.

To address these challenges, embodiments described herein teach an SRv6-enabled AI scheduler which can offer an open-standard, vendor-neutral solution that optimizes load distribution across network links, significantly enhancing cluster performance. In many embodiments, dynamic load balancing using Micro-Segment Identifier (uSID) lists are utilized by mapping the Queue Pairs (QPs) of the same source-destination pair (SRC, DST) to multiple disjoint uSID lists. This approach can ensure an even distribution of load across all links in the fabric, effectively mitigating polarization and congestion. Built on the open-standard Segment Routing over IPv6 (SRv6) framework, it can be fully interoperable with diverse vendor ecosystems, ensuring seamless compatibility.

In some embodiments, each uSID list is continuously monitored for health using Intelligent Path Monitoring (IPM), enabling rapid detection and response to path failures for enhanced resilience. Additionally, the solution offers deployment flexibility, as it can be implemented on either Network Interface Cards (NICs) or Top-of-Rack (ToR) switches, accommodating various infrastructure configurations.

In additional embodiments to address the polarization and congestion challenges in AI training clusters, a deterministic Source Routed AI Fabric can be utilized. For example, it is envisioned that various implementations may utilize SRv6 to steer traffic between GPUs, offering a scalable and open-standards-based method that enhances load distribution across network fabric links. Upon job orchestration, each source and destination (SRC, DST) may be mapped to multiple (K) disjointed uSID lists. These uSID lists may be precomputed with the specific objective of balancing traffic load across the network fabric by factoring in link utilization, using a weighted assignment that optimizes link usage and prevents congestion. It should be appreciated that the mechanism may be executed at the DPU (NIC) or at the TOR, depending on where we want to push the “intelligence”.

It is envisioned that the Scheduler, upon job orchestration, for each (SRC, DST) GPU pair it computes multiple disjoint uSID lists that are installed in both homing ToRs of the NIC associated with that GPU. The TOR receives an RDMA over Converged Ethernet v2 (ROCEv2) packet of the form: Eth, IP (SRC, DST), UDP, BTH (QP_identifier). The TOR steers all traffic for that (SRC, DST) into the set of uSID lists that were computed by the controller. The specific SID list to be used can be picked according to ECMP hashing using as input parameters (IP_SRC, IP_DST, UDP_Ports, QP_id). The routers along the DC fabric can steer according to the specific SID list. If, either through the congestion mechanisms (ECN, DCQCN) or through the IPM measurements, it is detected that that specific path is not performing well, then the uSID list can be disabled and the traffic is repathed or otherwise rerouted to another disjoint uSID list. It should be appreciated that the change from the old uSID list to the new uSID list may be flowlet-based (i.e., waiting for a specific amount of time without traffic within the flow to avoid any mis-ordering).

In many embodiments, the Scheduler computes multiple disjoint uSID lists for each source-destination pair (SRC, DST) during job orchestration. On the Network Interface Card (NIC), each Queue Pair (QP) can be assigned two uSID lists: a primary list and a backup list. The NIC crafts the ROCEv2 packet and adds an additional IPv6 header containing the uSID list associated with that QP. As the packet traverses the data center fabric, the routers steer it based on the specific SID list. If performance issues are detected through congestion mechanisms such as ECN or DCQN, or through Intelligent Path Monitoring (IPM) measurements, the system disables the affected uSID list and seamlessly switches to the backup list. The controller may subsequently install a new uSID list on the NIC to ensure optimal performance for future transmissions.

In additional embodiments, traffic associated with each QP may be evenly distributed across multiple, dynamically selected paths in the network fabric, effectively removing polarization without requiring proprietary solutions. By leveraging SRv6's capabilities, embodiments of the disclosure provide a resilient, standardized method for managing high throughput, synchronized GPU communication in AI clusters, thereby improving overall job completion times and network efficiency. Those skilled in the art will appreciate the open standard and interoperability of the embodiments described herein. Furthermore, the various mechanisms may be implemented on the NIC, or on the Top-of-Rack, thereby by adding flexibility to one or more deployment options. To that end, SID lists may be combined with IPM for health monitoring. Consequently, path disruption may be adjusted while maintaining optimal load distribution.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

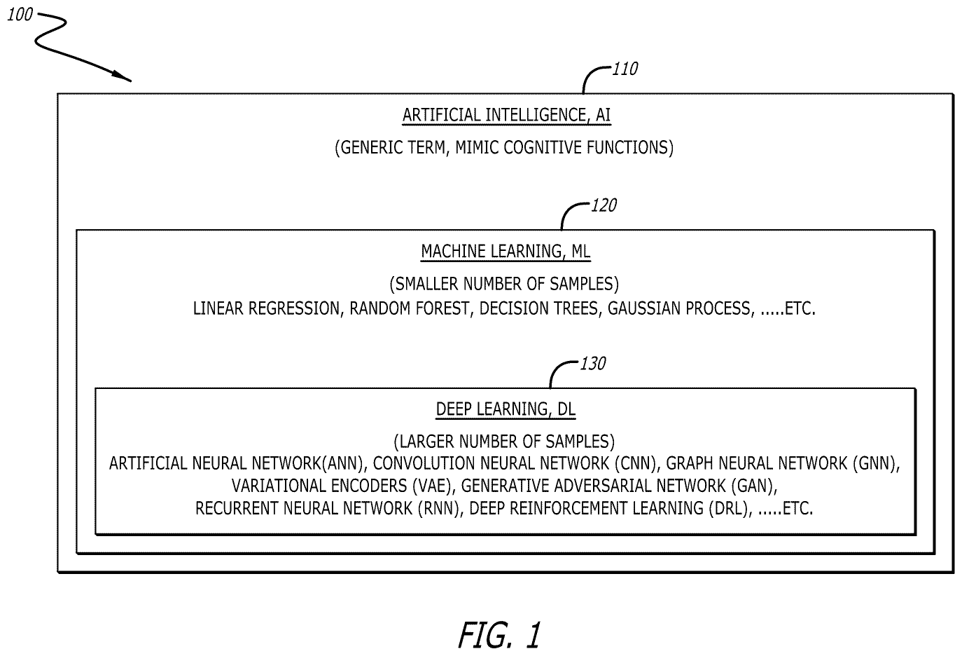

Referring to FIG. 1, a diagram 100 depicting various subsets of artificial intelligence in accordance with various embodiments of the disclosure is shown. Artificial intelligence (AI) 110 is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 110 can be considered a generic term because it encompasses a wide range of subfields and techniques, from simple rule-based systems to advanced machine learning and deep learning models. These AI techniques are used to simulate various aspects of human cognition. For example, machine learning (ML) 120 allows computers to learn from data patterns without explicit programming for each task, while natural language processing (NLP) enables machines to understand and generate human language. Deep learning (DL) 130, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 120 is a subset of Artificial Intelligence (AI) 110 that focuses on the development of algorithms and statistical models that enable computers to learn and make decisions from data without explicit programming. In traditional programming, a computer is given a fixed set of rules to follow, but ML 120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 120. These algorithms can handle various data types, including numerical, categorical, and structured datasets like spreadsheets or grids. One of the key strengths of ML is its ability to generalize from the training data to make accurate predictions on new, unseen data.

However, traditional ML methods rely heavily on feature engineering, wherein human experts manually identify the most relevant features or patterns within the data. For example, when using ML 120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 130 is a specialized subset of Machine Learning (ML) 120 that employs multi-layered artificial neural networks to automatically learn complex patterns and representations from large, often unstructured datasets. Inspired by the way the human brain processes information, DL 130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini batches can be utilized to prevent the network from becoming overly specialized to the training set.

CNNs are a specific type of ML 130 neural network designed to work particularly well with image data, making them highly relevant for image and video data processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction that is relevant to the underlying process being executed.

While CNNs are well-suited for grid-based data like images, many real-world problems in can involve non-grid data. This type of data may better be represented as a graph, where nodes represent entities (e.g., specific items) and edges represent relationships between them (e.g., characteristics, values, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an entity or the properties of a related to that or associated entities.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This can allow for the generation of new data by sampling points from the latent space. Similarly, GANs often consist of two components: a generator that creates fake/generated data and a discriminator that tries to distinguish between real and fake data. The two components can be trained in a competitive process where the generator tries to “fool” the discriminator, leading to increasingly realistic generated data.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex data simulations. In various embodiments, DRL can be used in scenarios where an optimal decision needs to be made. The combination of R^{L} and DL can allow for learning from raw data, making it a powerful tool for dynamic and real-time decision-making within various embodiments.

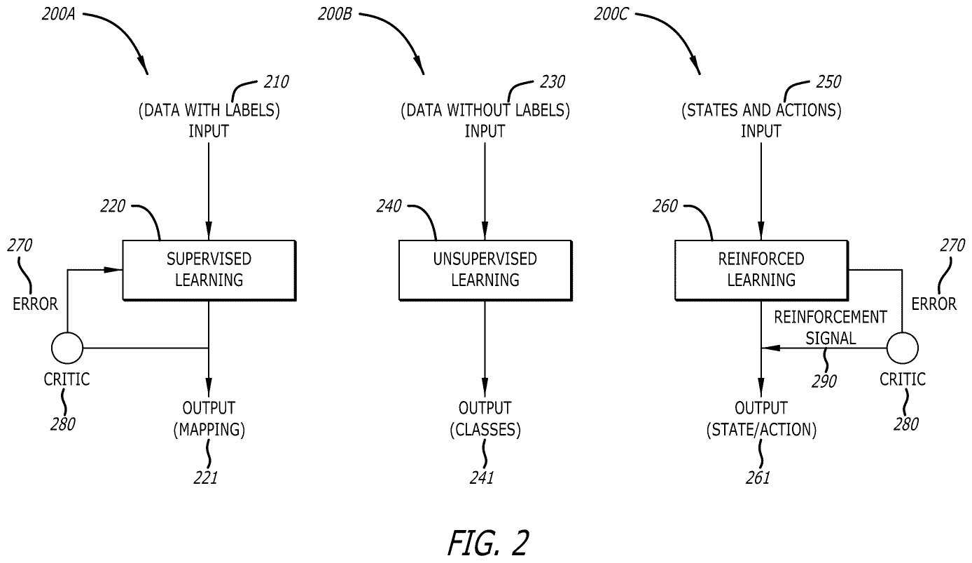

Although a specific embodiment for a diagram 100 depicting various subsets of artificial intelligence suitable for carrying out the various steps, processes, methods, and operations described herein is discussed with respect to FIG. 1, any of a variety of systems and/or processes may be utilized in accordance with embodiments of the disclosure. For example, other subset may be present and available for use within AI 110. Those skilled in the art will recognize that the diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-10 as required to realize a particularly desired embodiment.

Referring to FIG. 2, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates an output 221. However, the output data is often reviewed by a critic 280 that can determine one or more errors 270 that are fed back into the supervised learning model 220 for use in updating.

Supervised learning systems 200A are often considered the simplest machine learning model to understand in which input data (such as training data) has a known label or result as an output. So, the supervised learning model 220 can be understood to work on the principle of input-output pairs. As such, a function can be trained using a training data set, which is then applied to unknown data and makes some predictive performance. Supervised learning is task-based and mostly tested on labeled data sets.

Supervised learning systems 200A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve). Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain routing pathway is optimal or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P (y|X) of that class given a particular predictor. P (y) is the prior probability of that class, P (X) is the prior probability of the predictor, and P (X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features.

Again, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. Unsupervised learning models 240 can implement the learning process opposite to supervised learning, which means it enables the model to learn from an unlabeled training dataset. Based on the unlabeled dataset, the unsupervised learning model 240 can predict the output. Using an unsupervised learning system 200B, the unsupervised learning model 240 can learn hidden patterns from the dataset by itself without any supervision. In various embodiments, unsupervised learning models 240 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice an error 270 within the reinforcement learning model 260 actions, and adjust the outcome/output such that the “reward” or “punishment” is adjusted to better model the future behaviors or processing of the reinforcement learning model 260.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIGS. 1 and 3-10 as required to realize a particularly desired embodiment.

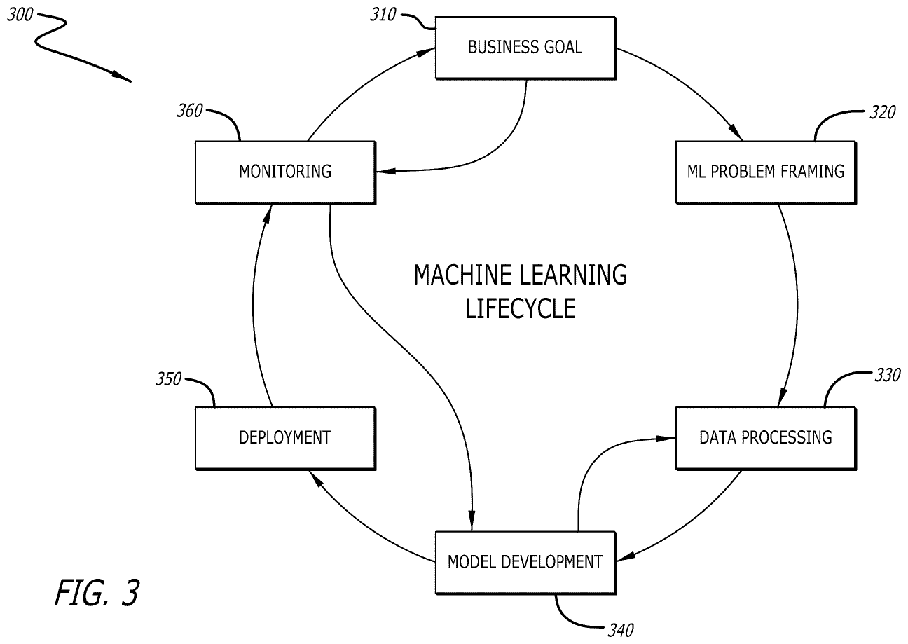

Referring to FIG. 3, a machine learning lifecycle 300 in accordance with various embodiments of the disclosure is shown. During the development of machine learning systems, the embodiment depicted in FIG. 3 can provide a framework for how to structure the design and maintenance of these systems. This machine learning lifecycle 300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 300 emphasizes that developing a machine learning model is not a one-time effort but an iterative process requiring ongoing monitoring and adjustment. The feedback loop inherent in the machine learning lifecycle 300 allows for continual refinement and optimization of models to maintain their accuracy and relevance.

In many embodiments, a first stage of the machine learning lifecycle 300 is identifying the business goal 310, which sets the overall direction and purpose of the ML project. This can involve understanding the specific problems or opportunities within the business or project that machine learning can address. A clear business goal 310 ensures that the project remains focused on delivering tangible value. Without a well-defined goal, it can be challenging to align the subsequent stages of the ML lifecycle 300, as the choice of model, data processing methods, and performance metrics can all depend on what the business aims to achieve.

Establishing a proper business goal 310 can also involve engaging with key stakeholders and developers to gather requirements and set success criteria. It can provide a roadmap that outlines what success looks like and helps in framing the ML problem. Clearly defined goals not only help guide the project but also provide benchmarks for evaluating the effectiveness of the deployed model once it enters production.

Once the business goal 310 is established, various embodiments take a next step involving ML problem framing 320, wherein the goal is translated into a specific machine learning task. This can involve selecting the appropriate type of ML problem, such as classification, regression, clustering, or recommendation, and defining the target variables or outputs. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively.

Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 330 can require or at least benefit from careful planning and iterative refinement. Once the data is processed, it is typically split into training, validation, and test sets to develop and evaluate the model, ensuring that it generalizes well to new, unseen data.

Model development 340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 330.

In further embodiments, deployment 350 is the stage where the developed model is integrated into the production environment to perform its intended tasks. This phase may involve setting up the necessary infrastructure, such as APIs or cloud-based services, to allow the model(s) to process live data and generate predictions. Deployment 350 can transform the model from a research tool into a functional component of a business process or product, providing real-time insights, automations, or decisions.

Proper deployment 350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 310.

In more embodiments, monitoring 360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 360, teams can identify when the model's performance drops and requires retraining or adjustments to align with the evolving data.

Monitoring 360 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 330 and model development 340, to refine the model(s) as needed. This iterative process allows the machine learning system to adapt and maintain its alignment with the original business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 3 may also be interchangeable with other elements of FIGS. 1-2 and 4-10 as required to realize a particularly desired embodiment.

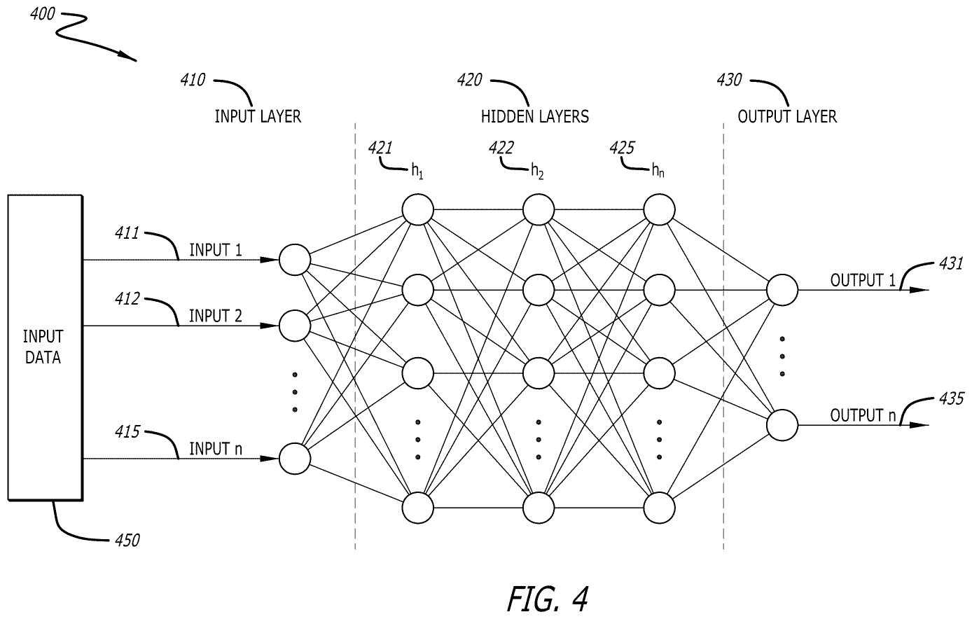

Referring to FIG. 4, an exemplary neural network 400 in accordance with various embodiments of the disclosure is shown. The embodiment depicted specifically depicts a feedforward neural network with multiple layers. This type of network consists of an input layer 410, one or more hidden layers 420, and an output layer 430. Each layer contains nodes (or neurons) that are interconnected, representing how data flows through the network. The input layer 410 can receive raw data, which is then processed by the hidden layers 420 through weighted connections and activation functions. These hidden layers 420 can enable the network to learn complex patterns and relationships within the data.

The final output layer 430 produces the network's predictions or classifications based on the processed input. The interconnected nature of the nodes allows the neural network 400 to learn from data during training by adjusting the weights of connections to minimize prediction errors. This structure is the foundation of deep learning models, as adding more hidden layers 420 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 400 depicted in the embodiment of FIG. 4, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 4 is presented as an exemplary ML solution that may be deployed within one or more methods or systems described herein.

In many embodiments, the input layer 410 is the first layer in a neural network 400 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 400 are generally scaled i.e., normalized to have a zero mean and/or unit standard deviation. Scaling can also be applied to the input of hidden layers (using batch or layer normalization) to improve the stability of neural network 400.

Unlike the hidden layers 420 and output layers 430, the input layer 410 typically does not perform any computations or transformations on the data. Its primary function is often to pass the input data to the next layer in the network, the first hidden layer 421. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 410 itself does not modify the data, it sets the stage for the neural network to extract complex patterns and relationships through the deeper layers. This flexibility in handling various types of input make the neural network 400 a powerful tool for a diverse set of applications.

With respect to the embodiments described herein, the input layer may be configured with a plurality of inputs providing input data 450. As those skilled in the art will recognize, input data 450 can vary in form, structure, or size based on the specific application desired. For example, in large language models, the input may be one or more tokens taken from an input provided by a user. The neural network 400 may also be a more specific step or sub-step within a larger AI/ML system. In some embodiments, the neural network 400 may be a part of a multi-layer perceptron within a large language model. However, as those skilled in the art will recognize, additional setups can be configured to format the input data 450 in a satisfactory way prior to processing by the neural network 400.

In a number of embodiments, the neural network 400 may comprise a plurality of hidden layers 420. The embodiment depicted in FIG. 4 comprises a first hidden layer 421, a second hidden layer 422, and an nth hidden layer 425, which are denoted as h₁, h₂, and hₙ respectively. In many embodiments, the hidden layers 420 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 421 h₁ receives direct input from the input layer, transforming the raw data into an initial set of features. For example, in an image recognition task, this layer might begin identifying basic patterns, such as edges or simple textures. The output of the first hidden layer 421 is then passed to a second hidden layer 422 h₂, which builds upon the features identified by the first hidden layer 421. This deeper layer might start recognizing more complex patterns, such as shapes or specific object components, by combining the lower-level features identified earlier. This can continue on until a last, nth hidden layer 425 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 421 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 430 is often the final layer in a neural network and is responsible for producing the network's predictions or classifications based on the information processed through the previous hidden layers 420. Each neuron in the output layer 430 can represent a specific outcome or category that the model can predict. In the embodiment depicted in FIG. 4, the outputs are labeled as “output 1” to “output n,” indicating that the network can be designed to have a varying number of outputs depending on the nature of the problem being solved for. For example, in a binary classification task (e.g., an email is spam vs. an email is safe), there would typically be a single output neuron that provides a probability score for one of the two classes/outcomes. In contrast, for multi-class classification (e.g., determining an optimal path from many to transmit data), the output layer would contain multiple neurons, each corresponding to a different class.

The number of neurons in the output layer 430 can also designed specifically for other types of tasks, such as regression, where the model can predict continuous values. In such cases, the output layer 430 might contain a single neuron representing a numerical prediction, such as the price of a house or the temperature forecast, etc. Alternatively, in complex applications like multi-label classification (where each input can belong to multiple classes simultaneously), the output layer 430 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 400 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. Additionally, the elements depicted in FIG. 4 may also be interchangeable with other elements of FIGS. 1-3 and 5-10 as required to realize a particularly desired embodiment.

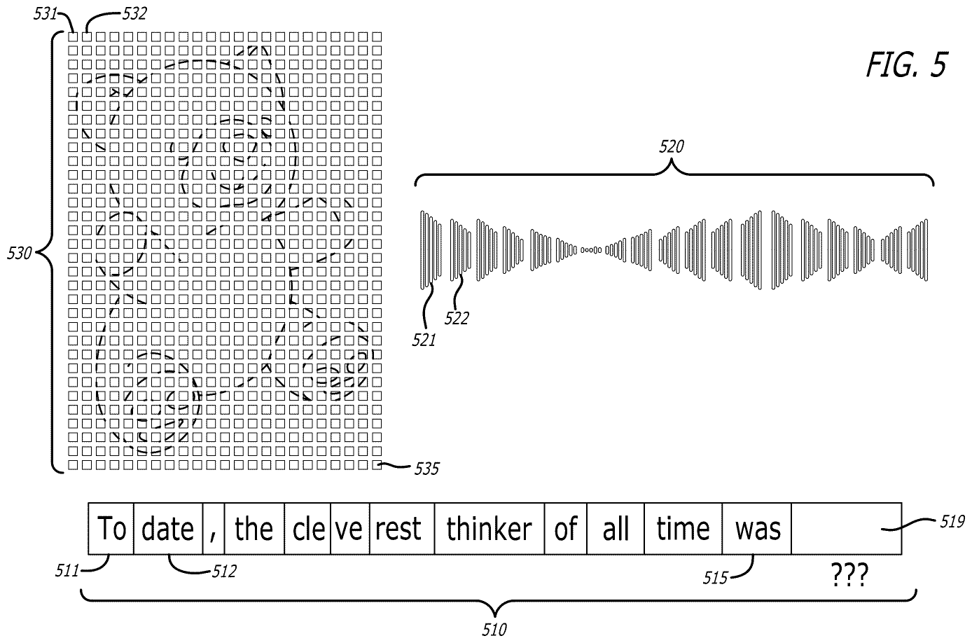

Referring to FIG. 5, a conceptual illustration of a variety of tokens for utilization within a large language model in accordance with various embodiments of the disclosure is shown. While most people are familiar with typing commands directly into a computer, interacting with a large language model (LLM) typically involves using prompts that are broken down into smaller units called tokens. These tokens can be segments of the original input prompt, such as individual words, subwords, or characters, allowing the model to process the prompt in manageable, structured pieces for a more nuanced understanding.

In fact, tokens are most often a fundamental unit of data used to represent a larger, general input for large language models (LLMs) and similar AI systems. In the context of LLMs, tokens are segments of text derived from the input prompt, where each token represents a manageable piece of the input, such as a word, part of a word, or a character. This segmentation can allow the model to break down complex text into simpler, consistent units that can be processed independently and then understood in relation to each other. By dividing input data into tokens, LLMs can handle language in a structured, flexible manner, adapting to diverse text inputs, from full sentences to specialized jargon or short phrases.

In many embodiments, tokens can serve as building blocks, enabling models to interpret language by analyzing these discrete parts and their relationships. For instance, in English, tokens often correspond to whole words, but when dealing with specialized vocabulary, slang, or languages with compound words, tokens might represent subwords or even single characters. This tokenization approach helps to maintain a balance between flexibility and precision, as smaller tokens allow the model to handle unfamiliar or highly specific terms more effectively. In a number of embodiments, each token can be encoded with a unique identifier that the model can use to differentiate it from others, preserving the distinct meaning or function it carries in context.

In the embodiment depicted in FIG. 5, a textual input prompt 510 is shown as divided up into a plurality of tokens. A first token 511 includes the word “To” while a second token comprises the next word “date”. In some embodiments, the first token 511 can be configured to include the space between “To” and “date”. This small change can be utilized by the LLM to further divine meaning from the textual input prompt 510. The number of tokens can vary depending on the type of input provided. This can extend from the first token 511 to the nth or last token 515 within the textual input prompt 510. This last token 519 can be utilized to indicate a requested or projected response 519.

Beyond text, similar tokenization principles may apply to other data types when used in models that process audio or visual input. For audio data, tokenization can involve dividing a sound file into slices, where each token might represent a short segment of audio, perhaps a fraction of a second or a small, meaningful slice of a larger waveform. By breaking audio down in this way, the model can analyze specific sounds, pitches, or rhythms within the context of the entire recording. This segmentation enables the model to interpret audio inputs in a structured format, similar to how language is tokenized, making it easier to process complex auditory patterns and understand sounds in a sequential manner.

In the embodiment depicted in FIG. 5, the audio input prompt 520 is shown divided into a plurality of audio slices. The first audio token 521 comprises a number of samples within the audio input prompt 520. Likewise, the second audio token 522 comprises a second number of samples within the audio input prompt 520. This slicing of the audio input prompt 520 can continue throughout the rest of the remaining audio such that when all tokens have been processed, the system can determine a best guess for the next audio token that should be appended to the end of the audio input prompt 520.

In the case of visual data, such as images, tokenization often involves segmenting the image into smaller chunks or patches, each of which becomes a visual token. These tokens represent different parts of the image, like color regions, edges, or textures, which the model can examine individually. Visual tokens enable the model to capture the intricate details within an image by focusing on manageable portions, while still considering their relationships to the broader visual structure. This approach allows AI systems to interpret complex images by analyzing these visual segments in the same way LLMs handle text tokens, offering a structured method for processing and understanding visual content.

In the embodiment depicted in FIG. 5, the image data prompt 530 is divided into a plurality of smaller visual tokens. The first visual input token 531 is shown as a small square portion of the original, larger image. This procedure of processing various chunks of the original image data prompt 530 can occur on these smaller portions of the image, such as the second visual input token 531, up to an including the nth visual input token 539. Each of these smaller visual tokens can be processed individually, but often in parallel to each other.

The concept of tokens is therefore versatile, allowing diverse types of input, whether text, sound, or images, to be converted into standardized, model-friendly formats. Tokenization creates a consistent framework for representing complex data types in a way that artificial intelligence systems can process effectively. This segmentation enables each model, regardless of the input type, to dissect and examine different parts of the data with a fine level of granularity, which is especially important when working with highly detailed or nuanced inputs. This tokenized structure can enable the model to interpret the input systematically, providing a foundation for further processing and understanding of the information encapsulated within each token.

Although a specific embodiment for a variety of tokens for utilization within a large language model suitable for carrying out the various steps, processes, methods, and operations described herein is discussed with respect to FIG. 5, any of a variety of systems and/or processes may be utilized in accordance with embodiments of the disclosure. In many non-limiting examples, the type and number of tokens can vary depending on the specific application desired and/or the amount of available processing power available to handle the input prompt. The elements depicted in FIG. 5 may also be interchangeable with other elements of FIGS. 1-4 and 6-9 as required to realize a particularly desired embodiment.

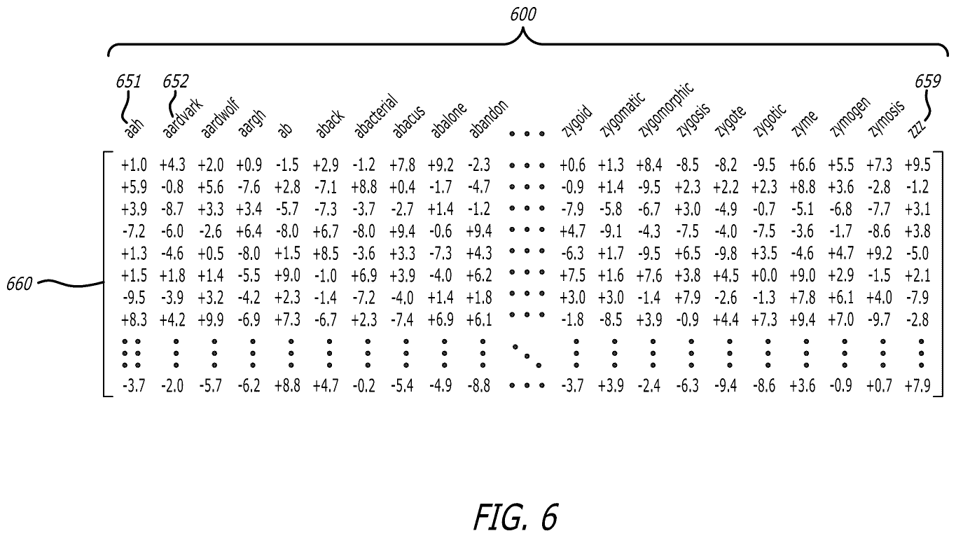

Referring to FIG. 6, a conceptual illustration of an embedding matrix 600 for a large language model, in accordance with various embodiments of the disclosure is shown. In many embodiments of large language models (LLMs), embedding matrices are components that enable the model to interpret tokens in a mathematically accessible way. An embedding matrix 600 is essentially a large table of vector representations, where each token in the model's vocabulary is assigned a unique vector, or array of numbers, that captures its initial meaning in relation to other tokens. When an input prompt is tokenized, each token can be matched with a corresponding entry in the embedding matrix 600. In a number of embodiments, this lookup process can provide the token with an initial value, or embedding, which represents the token in a multi-dimensional space. These embeddings allow the model to recognize patterns, relationships, and meanings in language beyond simple string matching, forming the foundation for all further processing within the model.

In a number of embodiments, each entry in the embedding matrix 600 is a vector of fixed size, with each dimension in the vector representing a distinct feature or aspect of the token's meaning. For example, words that are semantically or contextually similar may have embeddings that place them close to one another in this multi-dimensional space. This spatial relationship allows the model to capture a form of conceptual proximity wherein synonyms or related terms might occupy nearby areas in this space, while antonyms or unrelated words are farther apart. By assigning each token an embedding with specific values, the matrix can encode subtle linguistic and contextual information into numerical form, enabling the model to work with tokens in a highly structured, yet flexible, manner.

In the embodiment depicted in FIG. 6, the embedding matrix 600 is associated with every known word in the English language. In other words, the matrix has a column associated with each of the around 50,000 or so words in English. Each column of the embedding matrix 600 comprises a vector 660 which associates the corresponding word to a location with a multi-dimensional space. For example, the first word 651 “aah” has a corresponding vector 660 from the first entry +1.0, to the nth entry −3.7. Likewise, the second word 652 “aardvark” has another column of vector values associated with it starting at +4.3 and ending in −2.0. Finally, the nth word 659 “zzz” is associated with a corresponding vector 660 that includes the values in the column starting at +9.5 to +7.9. As each token is processed, it is assigned the corresponding vector 660 taken from the embedding matrix 600.

The embedding matrix 600 is typically learned during the model's training phase. As the model is exposed to vast amounts of text, it iteratively adjusts the values in the embedding vectors to capture the relationships between tokens more accurately. Through this process, embeddings evolve to represent the associations, contexts, and distinctions that the model has observed across its training data. For instance, words that frequently appear together or in similar contexts may have embeddings that reflect this association. The embedding matrix 600 thus serves as a kind of “knowledge base” for initial token relationships, giving the model a structured way to approach the vast variability in language.

This embedding approach is highly efficient because it enables the model to generalize across contexts and recognize similarities even with previously unseen tokens. For example, even if a token or phrase in a prompt has not been encountered during training, the model can infer its meaning based on the embeddings of other, similar tokens. This generalization is possible because embeddings capture both specific meanings and broader patterns, allowing the model to interpret novel inputs based on its learned understanding of language structure and relationships. By embedding tokens in a shared space, the model can gain a foundational understanding of language that it can apply across various prompts and contexts. This arrangement can allow the LLM to move beyond a rigid, word-by-word interpretation and instead engage with language as a rich network of interconnected meanings and ideas.

Although a specific embodiment for an embedding matrix for a large language model suitable for carrying out the various steps, processes, methods, and operations described herein is discussed with respect to FIG. 6, any of a variety of systems and/or processes may be utilized in accordance with embodiments of the disclosure. For example, similar concepts associated with the embedding matrix 600 of FIG. 6 can be applied to other types of embedded matrices associated with other data types. It is contemplated that the embedding matrix is only limited by the types of input data that it is configured to process. The elements depicted in FIG. 6 may also be interchangeable with other elements of FIGS. 1-5 and FIGS. 7-9 as required to realize a particularly desired embodiment.

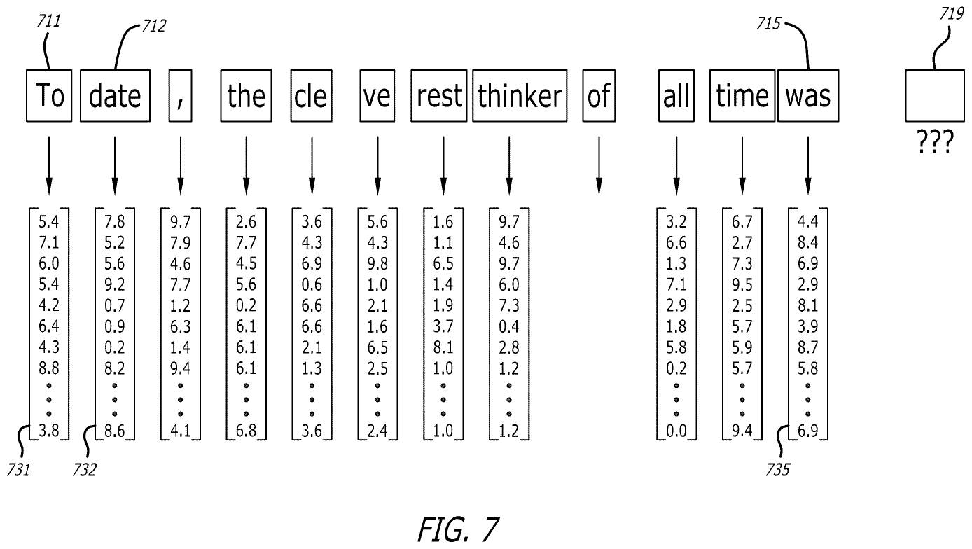

Referring to FIG. 7, a conceptual illustration of an input prompt converted from a series of tokens into a series of tensors in accordance with various embodiments of the disclosure is shown. In many embodiments, when an input prompt is converted into tokens, each of these tokens is then transformed through an embedding matrix to yield a unique vector representation, known as an embedding. This embedding is often a numerical array, or tensor, that encodes the token's position, context, and meaning within a multi-dimensional space. Essentially, once the tokenized prompt passes through the embedding matrix, each token is matched with a tensor that captures both its individual characteristics and its relationships to other tokens in the model's vocabulary. These tensors form the foundational representation of the prompt, providing structured data that the model can process to understand and generate contextually relevant responses.

Each tensor associated with a token after embedding can represent a fixed number of dimensions, often hundreds or even thousands, depending on the model's architecture. These dimensions give the tensor a rich structure, with each element in the tensor reflecting different features of the token's meaning. For instance, certain dimensions might encode aspects related to semantic similarity, part of speech, or contextual nuances observed during training. By encoding these complex features into a tensor, the model gains a detailed, flexible understanding of the token's role in the input prompt, which becomes critical for capturing context, sentiment, and intent in language processing tasks.

In various embodiments, the collection of tensors generated from the embedded tokens can create a high-dimensional representation of the entire prompt, with each tensor holding a unique set of values corresponding to its specific token. Because each tensor encodes information about a single token, the model can recognize patterns in the prompt by examining the relationships between these tensors. For example, words that often appear together may have similar values in certain dimensions of their tensors, allowing the model to capture implicit relationships and context within the input. This organized structure of tensors provides the model with a map of the prompt that it can analyze to make inferences about meaning, order, and emphasis.

In the embodiment depicted in FIG. 7, the first token 711 is associated with the word “To” and has a corresponding tensor 731 which is an array in multi-dimensional space. Likewise, the second token 712 is associated with a second tensor 732. Each token within the input prompt is subsequently associated with a corresponding tensor, up to the last and nth token 715 which is associated with the nth tensor 735. Processing these input prompt tokens will yield a projected or otherwise best fit for what the next token/word 719 will be.

In further embodiments, the use of tensors can allow the model to handle complex language structures efficiently, as each token's tensor can interact with others in ways that reflect natural language dependencies. By representing each token as a tensor, the model can apply various mathematical operations across these tensors to analyze and synthesize information. These operations enable the model to determine which tokens are most relevant to one another within the context of the prompt. For instance, determining the vector difference between two related words like “man” and “woman” may be applied to a different context to determine similar words like applying that same vector difference to the vector associated with “uncle” to lead to the vector associated with the word “aunt”.

Although a specific embodiment for an input prompt converted from a series of tokens into a series of tensors suitable for carrying out the various steps, processes, methods, and operations described herein is discussed with respect to FIG. 7, any of a variety of systems and/or processes may be utilized in accordance with embodiments of the disclosure. For example, the number of elements within a tensor can number in the thousands, or even tens of thousands, depending on the complexity of the model. Additionally, in various embodiments, the position of the token within the input prompt can also be encoded within the tensor, which may be done by processing some additional value to the original tensor. The elements depicted in FIG. 7 may also be interchangeable with other elements of FIGS. 1-6 and FIGS. 8-10 as required to realize a particularly desired embodiment.

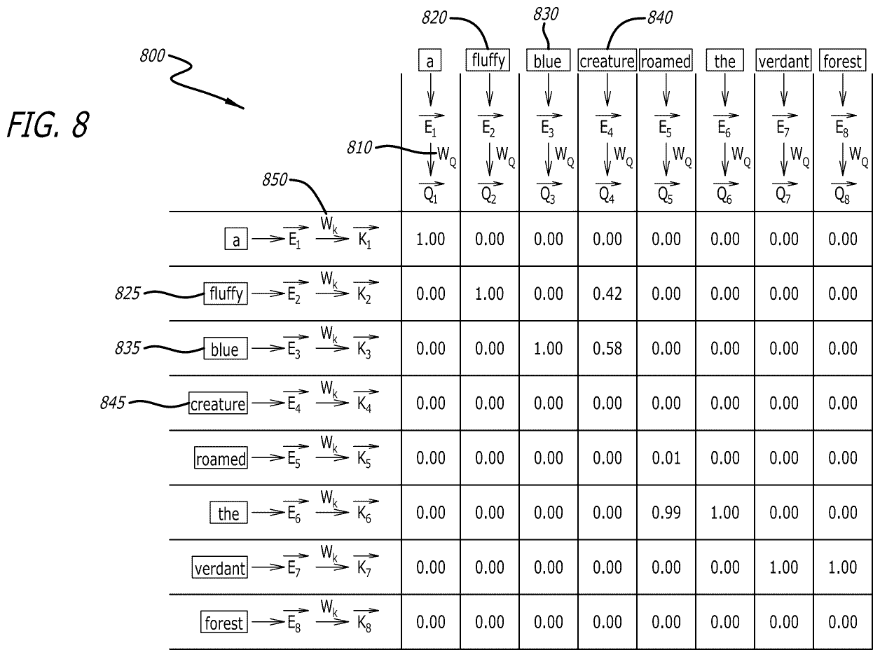

Referring to FIG. 8, a conceptual illustration of an attention layer process 800 within a large language model in accordance with various embodiments of the disclosure is shown. When processing languages such as English, understanding the context of each word or token within an input prompt is beneficial. As such, many embodiments herein comprise at least one attention layer for processing the embedded tokens.

Take for example, the following three sentences: “I saw an American shrew mole,” “Measure one mole of carbon dioxide,” and “Take a biopsy of that mole”. Each of these sentences utilize the word “mole” in distinct contexts, demonstrating how language can carry multiple meanings based on surrounding words and phrases. In natural language processing, understanding these varied meanings requires the model to consider each token in relation to its neighbors, which is where attention layers become crucial. By focusing on the surrounding context of each instance of “mole,” an attention layer can discern whether it refers to an animal, a unit of chemical measurement, or a skin lesion. In many embodiments, the context, or set of nearby tokens, can allow the model to assign different meanings to “mole” depending on which other words are present, such as “American shrew” in the first case, “carbon dioxide” in the second, and “biopsy” in the third.

In a number of embodiments, attention layers can enable the model to weigh the relevance of each neighboring token to identify the specific meaning of “mole” in each phrase. For example, in “An American shrew mole,” the attention mechanism can emphasize the tokens “American” and “shrew,” which typically appear in contexts related to animals, thus guiding the model to interpret “mole” as a small mammal. Conversely, for the phrase “One mole of carbon dioxide,” however, the presence of “carbon dioxide” and the numerical term “one” shifts the focus toward scientific terminology, signaling that “mole” refers to a unit of chemical measurement. Similarly, in “Take a biopsy of that mole,” attention is drawn to the medical term “biopsy,” leading the model to interpret “mole” as a skin lesion. Through this mechanism, attention layers allow the model to dynamically adapt its understanding of words based on context, handling polysemous terms (words with multiple meanings) with greater accuracy.

In this way, attention layers can help the model “tease out” the correct meanings by selectively focusing on relevant tokens within the prompt. By assigning higher weights to contextually significant words, the model can make nuanced distinctions between different senses of the same token. This ability to disambiguate words based on context is essential for LLMs to generate accurate and meaningful responses, as it enables them to navigate the inherent complexity and flexibility of human language.

In literature, the generation of “attention” with these attention layers is described as:

$$Attention ( Q , K , V ) = softmax ( \frac{{QK}^{T}}{\sqrt{{d}_{k}}} ) V$$

Wherein Q represents the query matrix which itself is a placeholder for the “query” vectors derived from each embedded token in the input sequence. When processing language, each token (or word) is associated with a specific query vector that encodes what that token is “looking for” in other tokens within the sequence. In many embodiments, these query vectors are produced by multiplying the token embeddings by a learned weight matrix specific to the queries. The query serves as a way for the model to actively seek out relevant information from other tokens, allowing it to identify connections or dependencies between different parts of the sequence. Thus, queries capture the intention or focus of each token as it interacts with the rest of the input.

K is associated with the key matrix consisting of “key” vectors, which are similarly derived from the input sequence. Each token has an associated key vector that represents the essential information it holds. While queries represent what each token is searching for, keys encode what each token offers in terms of information. Keys are generated by multiplying token embeddings with a learned weight matrix distinct from that used for queries. The relationship between queries and keys determines how strongly one token will attend to another, allowing the model to weigh the relevance of each token to each other token within the sequence.

The term QK^{T} therefore represents the dot product between the query and key matrices. This operation calculates the similarity (or relevance) between each query vector and each key vector, effectively measuring how much attention one token should give to another. The resulting score indicates how strongly each token should focus on every other token, capturing the relationships within the input sequence. This relevance score is fundamental to the attention mechanism, as it serves as the basis for distributing focus across the sequence.

Within the above equation, V stands for “value”, insomuch as a value matrix contains “value” vectors, which can represent the actual content information associated with each token. Unlike queries and keys, which often work to determine the relevance of tokens to each other, values contain the data the model will pass along through the attention layer. Value vectors are produced by multiplying token embeddings with a learned weight matrix specific to values. These value vectors carry the contextual information that the model will use when constructing output, ensuring that the information emphasized by the attention mechanism is carried forward in processing.

The division by \sqrt{dₖ} is a scaling factor where di denotes the dimensionality of the query and key vectors. Without this scaling, the dot product values in QK^{T} could become large as the number of dimensions increases, which would push the SoftMax function towards extreme values, creating an unstable learning process. By scaling with \sqrt{dₖ}, the model normalizes the scores, keeping gradients more manageable and stabilizing the SoftMax output, which aids in more effective learning and model convergence.

In the embodiment depicted in FIG. 8, an input prompt of “a fluffy blue creature roamed the verdant forest” is being processed through the attention filter 800. Each of these tokens, such as the first token 810 are subject to processing through a query vector 810 shown as W_{Q}. In a very simplistic way (and described herein for illustrative purposes), the token has an associated query vector 810 that can “ask” questions in a numerical way such as, but not limited to, “are there any adjectives in front of me”? In response, words that are adjectives before the creature token 840 are more likely to be activated later on.

Specifically, each token has an associated vector/tensor written down herein as E₁, E₂ onward to E₈. Each of these vectors/tensors can be multiplied by or otherwise processed by a corresponding query matrix (shown as W_{Q}) to generate a query vector, denoted by Q₁, Q₂ onward to Q₈. Likewise, the same tokens, such as the first key token 825, second key token 835, and fourth key token 845 can be processed through a key matrix (shown as Wₖ) to generate a corresponding key vectors denoted by K₁, K₂, and the like. Finally, for each token, the dot product of the query vector and key vector are determined. These values are then operated on through a type of SoftMax filter to generate a specific format of numbers such that each value will be placed between 0 and 1, and the sum off all values within a column shall be equal to 1. In this way, we can see that the “fluffy” token 820 and “blue” token 830 output a large value in association with the token “creature” as those tokens are adjectives describing the creature token 840. Similar values appear when “the” and “verdant” are compared to the token “forest”.

In a variety of embodiments, the result of this dot product is an “attention vector” that can be added to the original vector such that a new modified attention vector is created. The goal is to move the vector associated with the token to a spot on the multi-dimensional space that is closer to other related terms. This output can then be sent to one or more multi-layer perceptron (MLPs).

Although a specific embodiment for an attention layer process 800 within a large language model suitable for carrying out the various steps, processes, methods, and operations described herein is discussed with respect to FIG. 8, any of a variety of systems and/or processes may be utilized in accordance with embodiments of the disclosure. For example, the process described herein with reference to FIG. 8 and the attention models is presented in a simplistic fashion in order to allow for increased comprehension. However, those skilled in the art would recognize that other steps or attention model types may be utilized such as, but not limited to multi-head attention, and multi-head attention. The elements depicted in FIG. 8 may also be interchangeable with other elements of FIGS. 1-7 and FIG. 9-10 as required to realize a particularly desired embodiment.

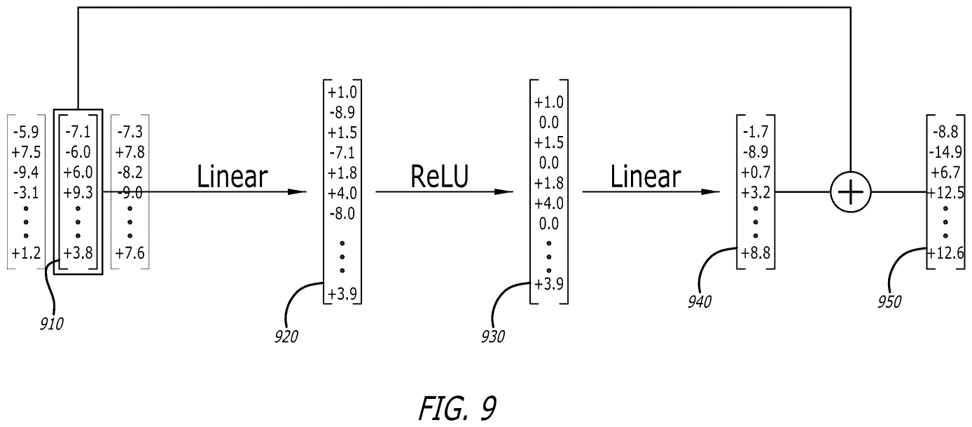

Referring to FIG. 9, a conceptual illustration of a multi-layer perceptron within a large language model in accordance with various embodiments of the disclosure is shown. In many embodiments within large language models (LLMs), multi-layer perceptrons (MLPs) play a role in refining and processing information after it has passed through the attention layers. MLPs, in the context of LLMs, are often positioned after each attention layer to add further transformations to the information embedded within each token. After the attention layer has modified each token's vector based on context and relationships with other tokens, this modified vector is then passed through an MLP. This MLP typically consists of a sequence of linear transformations, combined with a non-linear activation function, such as ReLU (Rectified Linear Unit). By applying these transformations, the MLP can help to fine-tune the representation of each token, capturing essential details and storing “factual” information that the model may rely on later.

The process can begin with a linear transformation, which expands the dimensions of the modified vector 910, essentially mapping it to a higher-dimensional space. In the embodiment depicted in FIG. 9, the original modified vector 910, which is typically an output of an attention layer, is processed through a linear transformation to yield a first output vector 920. This initial expansion can allow the MLP to encode more complex information within each vector, giving it more capacity to capture and retain meaningful details.

After this expansion, various embodiments can apply a ReLU activation function, which introduces non-linearity into the processing. ReLU is particularly effective because it enables the model to focus on positive values within the vector, setting any negative values to zero. This step allows the model to highlight certain features within the token's vector while suppressing others, helping it differentiate important from less relevant information within the encoded representation. In the embodiment depicted in FIG. 9, the ReLU output vector 930 is subsequently processed through another linear transformation.

In a number of embodiments, this second linear transformation can down-project the vector back to its original dimensionality. This step can ensure that the output from the MLP has the same dimensions as the input vector, allowing for a consistent vector size across all layers. The output vector 940 from this down-projection is then added back to the original modified vector from the attention layer, creating what's known as a residual connection 950. This residual connection 950 combines the newly refined features from the MLP with the original contextual information produced by the attention layer. This approach enhances stability during training and allows the model to retain both the relational context and the refined factual details within the token's representation.

In the broader architecture of LLMs, MLPs are often considered the component where “facts” are stored. While the attention mechanism focuses on identifying relationships and associations between tokens, essentially, contextualizing each word within the sentence structure, the MLPs focus on enriching each token's representation with more granular, content-specific details. Through the repeated application of MLPs across multiple layers, the model can accumulate and consolidate information, effectively “remembering” facts and attributes associated with different words or phrases. This allows LLMs to recall specifics about language usage, word meanings, and even broader real-world information encoded in the training data.

In contrast, the attention layers are where the “associations” are stored, focusing on dynamically adjusting each token's focus depending on its context within the input sequence. Attention layers determine how strongly each token should relate to others, capturing nuances like syntax, grammar, and context-sensitive meanings. While attention layers dynamically build context, MLPs hold onto factual representations that serve as the knowledge base within each layer. Together, the attention and MLP layers enable the model to balance understanding relationships with retaining concrete information, resulting in a robust representation of both context and knowledge.

In a number of embodiments, input data often passes through multiple rounds of attention filters and multi-layer perceptron (MLP) layers, forming a sequence of transformations that incrementally refine the model's understanding of the input before reaching the final output stage. Each layer in the transformer model, the architecture commonly used for LLMs, includes both an attention component and an MLP component, with these two parts working in tandem to progressively deepen the model's comprehension of the text. This sequence is repeated over numerous layers, allowing the model to develop a sophisticated representation of the entire input sequence through cumulative transformations. By the end of these repeated passes, each token vector holds a highly nuanced, multi-dimensional understanding of the prompt. Once all layers have processed the data, the final, refined vectors proceed to the unembedding stage, where they are mapped back to language tokens that represent the model's predicted output.

Although a specific embodiment for a multi-layer perceptron within a large language model suitable for carrying out the various steps, processes, methods, and operations described herein is discussed with respect to FIG. 9, any of a variety of systems and/or processes may be utilized in accordance with embodiments of the disclosure. For example, as those skilled in the art will recognize, the specific layout and structure of the MLP layer can vary depending on the specific application desired. The elements depicted in FIG. 9 may also be interchangeable with other elements of FIGS. 1-8 and 10 as required to realize a particularly desired embodiment.

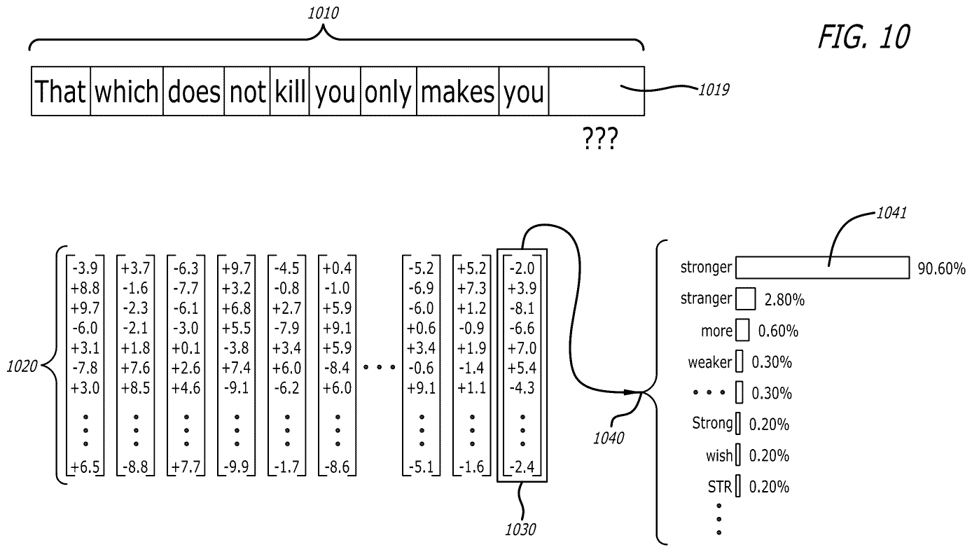

Referring to FIG. 10, a conceptual illustration of an unembedding process within a large language model in accordance with various embodiments of the disclosure is shown. In many embodiments, the final stage of a large language model's (LLM) processing is called unembedding, where it transforms the refined vectors from the last layer back into a probability distribution over potential output tokens. This stage is useful because it can allow the model to generate language tokens that represent the most likely continuations or responses to the input prompt. To achieve this, each vector (representing a token in the sequence) is mapped back to the model's vocabulary, which may contain tens of thousands of possible tokens. Unembedding utilizes a learned matrix, similar to the embedding matrix used at the input stage, but in reverse. Instead of converting tokens into vectors, it translates the processed vectors back into a set of potential language tokens that the model can output.

In a number of embodiments, the matrix output 1020 from the unembedding process is a final array 1030 where each entry corresponds to a probability score for a potential token. This probability distribution indicates how likely each word or phrase is to follow the input sequence, based on the context the model has built through its layers of attention and MLP processing. For instance, if the input prompt 1010, such as in the embodiment depicted in FIG. 10, is “That which does not kill you only makes you,” the unembedding process will produce a ranked list of possible next words. In this case, the word “stronger” might appear as the most probable continuation, with a high probability score. In FIG. 10, the probability of the “stronger” token response 1041 within the list of possible token responses 1040 is shown as 90.60 percent. This reflects the model's understanding of common phraseology and context, identifying “stronger” as a likely completion due to its frequency and relevance in similar contexts within the training data.

The ranked list produced during unembedding may include other potential outputs, each with an associated probability score that indicates its relative likelihood. For example, the word “stranger” could appear as a less probable continuation, with a probability of 2.80 percent, still present in the ranked list but much lower than “stronger.” This ranking reflects the model's capacity to recognize alternative continuations, including those that might follow less conventional but still possible language patterns. Other words, such as “more” or “weaker,” may also appear on this list, each with its own probability based on the contextual and semantic associations the model has learned. This probabilistic approach allows the model to produce flexible responses and make informed guesses about the next token in a way that mimics human language prediction.

The unembedding process may not only provide a ranked list of potential next words but also enable the model to maintain flexibility in generating responses. Depending on the application, the model might choose the highest-ranked token for a precise and likely output, or it could sample from the probability distribution to introduce variability, which can be useful in creative text generation or conversational applications. By examining the distribution of probabilities across potential tokens, the model can adapt its output strategy to different tasks, choosing the most probable word for accuracy or exploring lesser probable options for creative responses. This versatility is one of the reasons LLMs are effective across diverse language tasks, from completing sentences to generating open-ended stories.

The probability distribution generated in the unembedding phase reflects the culmination of all previous processing steps, encapsulating the context, associations, and factual information encoded within the model. Each token's probability is informed by the layers of attention and MLP transformations, which allow the model to build a nuanced understanding of the input. By ranking potential outputs, the model can provide a final “decision” on the next token based on its understanding, with the unembedding process acting as a bridge between the abstract, high-dimensional vector space within the model and the concrete language output we see.

In further embodiments, the LLM can generate entire sequences of text by using its own output as the input for subsequent steps, allowing it to create a series of tokens that form coherent responses or passages. Once the model generates a probable next token, it can feed this token back into its input pipeline, treating it as the next part of the prompt. This iterative process enables the model to build on each newly generated token, maintaining continuity and context with each step. For example, if the initial prompt is “The sky is,” and the model predicts “blue” as the most probable next word, it can then take “The sky is blue” as the new input. By repeating this cycle, the LLM can produce extended responses, updating its understanding of context and adjusting its predictions as it goes along. This feedback loop allows the model to generate complex, contextually aligned sequences, whether for completing sentences, generating stories, or engaging in conversational responses, all by sequentially predicting and incorporating each token into its evolving context.

Although a specific embodiment for an unembedding process within a large language model suitable for carrying out the various steps, processes, methods, and operations described herein is discussed with respect to FIG. 10, any of a variety of systems and/or processes may be utilized in accordance with embodiments of the disclosure. For example, the output for other types of models can be token related to images, sounds, or other data format types. The elements depicted in FIG. 10 may also be interchangeable with other elements of FIGS. 1-9 as required to realize a particularly desired embodiment.

### Root Cause Analysis (RCA)

Root cause analysis (RCA) is a process that determines the main cause of a problem, such as within a networking environment and pertaining to an operating state of a machine, network traffic flow, networking services, etc. This main cause may be the ultimate cause that leads to the failure of a component or a system. Finding the root cause is important in preventing the problem from occurring again in the future, resolving any current issues such as machine failures, networking services downtime, poorly performing KPIs, and/or preventing a larger issue from occurring (e.g., machine failure due to overuse). In many cases, a root cause is masked by other secondary causes and the solution to these secondary causes may only work temporarily. Due to the complexity of many systems, especially systems employing several software or hardware components that interact with one another in an environment with limited resources such as memory or CPU utilization, the process to trace a problem to a root cause is typically tedious, time consuming, costly, and may even be unsuccessful. An automated one-click RCA functionality is a response to this tedious and inefficient process. In an example instance, when an event triggers an alert, the user receives the alert and is tasked with finding out the cause. With the one-click RCA functionality enabled as disclosed herein, the user may need only to click on a single button to obtain the result (e.g., provide a single instance of user input to a user interface (UI) component). Thus, the user does not have to be an experienced user or a professional well versed in the technologies. The one-click RCA therefore provides a seamless alert workflow with precision and accuracy. By covering the entire path of troubleshooting, the one-click RCA covers all the application, infrastructure and network domains for efficient troubleshooting.

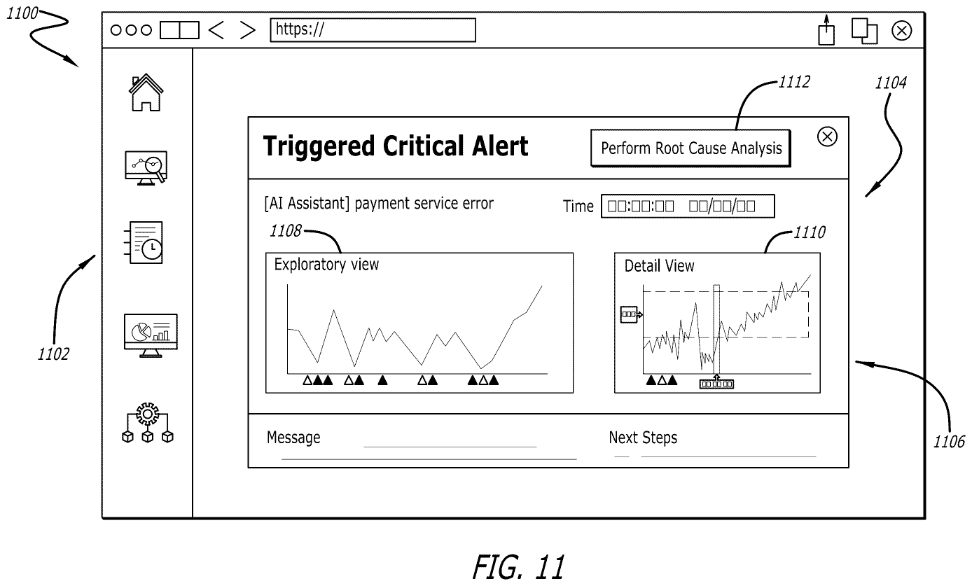

FIG. 11 is an illustrative graphical user interface (GUI) alert pop-up window including a user interface (UI) component configured to receive user input to initiate an automated root cause analysis in accordance with various embodiments of the disclosure. FIG. 11 illustrates a webpage 1102 displayed on a display screen 1100 of a networking device. In the example shown, the webpage 1102 is a dashboard for a comprehensive, integrated solution designed to provide real-time, full-stack visibility across an information technology (IT) environment (“observability product”).

Many IT departments of enterprise companies deploy an observability product as a result of the recent explosion in available data and the consequently the number of KPIs being monitored in order to automate the monitoring, analyzing, and viewing of the data used in KPIs as well as the resultant KPIs themselves. In some instances, an observability product may include logic that, upon execution by one or more processors, automatically obtains the required data for a particular KPI, performs any analysis, manipulation, or filtering needed, and generates a graphical user interface (GUI) configured to display the KPI and any analysis results. One example of such a GUI may be the alert pop-up window (“alert window”) 1104 displayed in front of the webpage 1102. The alert window 1104 is shown to include a body component comprised of at least data display modules 1108, 1110 that provide some illustrative indication as to the alert. For example, display module 1108 provides a graphical display of a metric, e.g., an error rate for a payment service, over a first time window, e.g., a one hour time frame. The display module 1110 may provide a graphical display of the same metric in a detailed view, e.g., over a 20 minute time frame and provide a visual threshold. Thus, the display modules provide some information to a user as to the metric that triggered that alert.

However, as shown, the information that may be gleaned from such an alert is limited to identifying the metric to which the alert belongs, a time that the metric exceeded a threshold, and possibly the threshold value. As should be realized, in many instances, providing an understanding of a metric and a time at which a threshold value was triggered provides little context for a user to understand what caused the metric to exceed the threshold, and importantly, how to remediate the issue.

To provide a technical improvement by at least providing a user with a method for determining what caused the metric to exceed the threshold, or more generally, what triggered an alert, the invention of the disclosure provides a user interface (UI) component 1112 that is configured to receive user input resulting in the initiation of a root cause analysis (RCA). As shown in FIG. 11, the UI component 1112 may be a button provided on directly on the alert that enables a user to easily initiate a root cause analysis, e.g., a “1-click RCA,” which derives its name from the ability for the user to provide user input as one click to initiate the RCA to investigate the cause of the alert. The following discussion and accompanying figures will detail how the providing user input to the UI component 1112 (e.g., activating the UI component 1112) initiates an automated root cause analysis, which may be performed by an RCA logic in cooperation with a large learning model (LLM). In some examples discussed below, the RCA may be performed by the RCA logic and an orchestration agent that is configured to invoke one or more sub-LLMs and/or logic modules to respond to a prompt instructing the orchestration agent to perform an RCA based on certain parameters generated by the RCA logic. In such examples, the RCA logic, the orchestration agent, the sub-LLMs, and the logic modules may collectively comprise an artificial intelligence (AI) assistant.

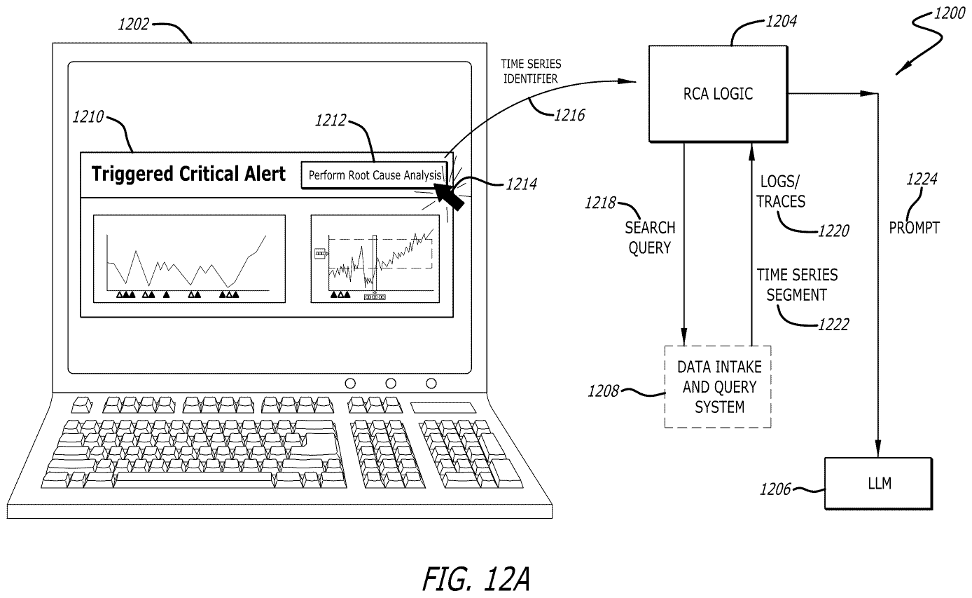

FIGS. 12A-12B provide an illustrative operational flow in the performance of an automated root cause analysis through deployment of a large language model (LLM) following receipt of user input to the GUI alert pop-up window such as that shown in FIG. 11 in accordance with various embodiments of the disclosure. FIGS. 12A-12B illustrate a networking environment 1200 that is comprised of a networking device 1202, an RCA logic 1204, an LLM 1206, and optionally, a data intake and query system 1208. The operational flow of FIG. 12A illustrates the operational flow of data transmission and logical operations performed beginning with the initiation of an RCA in response to the receipt of user input, processing of information related to an alert, retrieval of necessary data from storage, and generation of a prompt for an LLM. The operational flow of FIG. 12B continues the operational flow of data transmission and logical operations shown in FIG. 12A by illustrating data transmission from the LLM to the RCA logic in response to the prompt and generation of a GUI displaying results of the processing by the LLM.

More specifically, referring to FIG. 12A, the operational flow begins when user input 1214 is received at a UI component 1212, e.g., a selectable button, where the user input corresponds to activating the UI component 1212, which may be included in an alert 1210, similar to the instance shown in FIG. 11. As discussed above with reference to FIG. 11, the alert 1210 may be rendered on a display screen of the networking device 1202 and correspond to an alert generated following processing of logic of an observability product resulting from automated monitoring metrics and/or KPIs. The activation of the UI component 1212 through user input 1214 may result in a data transmission 1216 operation to the RCA logic 1204, where the data transmission may include certain information pertaining to the alert 1210 such that an identifier of a time-series metric to which the alert 1210 pertains, a time range illustrated in the alert, a monitored KPI to which the time-series metric pertains (contributes), and optionally, tokens or user credentials enabling the RCA logic 1204 to access certain datastores or databases storing the time-series metric and traces/logs that may be relevant to the RCA. For instance, activation of the UI component 1212 may correspond to a request for automated performance of a root cause analysis in view of the alert 1210.

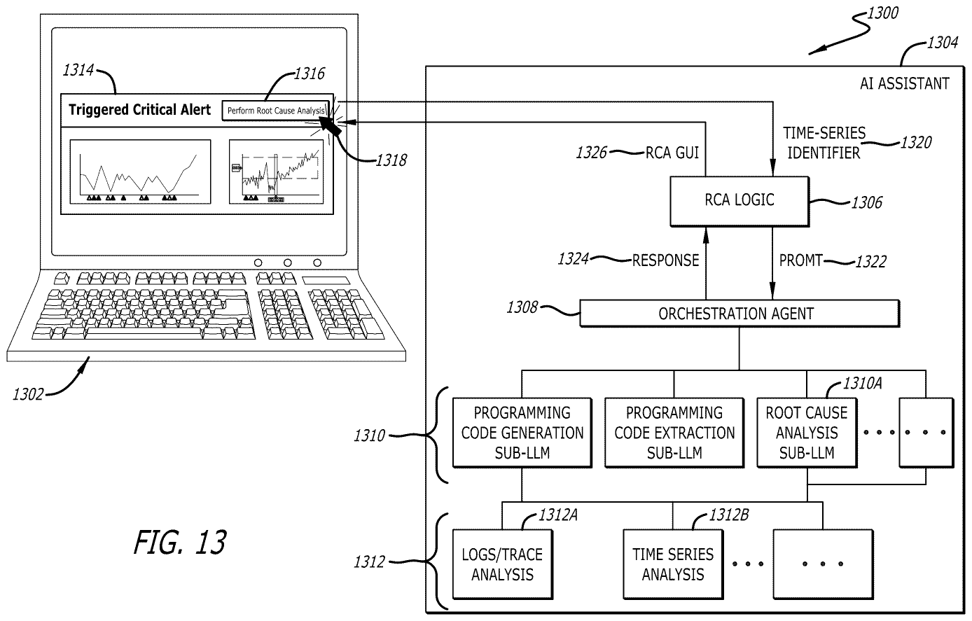

The RCA logic 1204 receives the data transmission 1216 initiated by the user input 1214 and performs operations including anomaly detection methodologies, trace/log searches, prompt generation, and transmitting the prompt to the LLM 1206. More particularly, in some implementations, upon receiving the data transmission 1216, the RCA logic 1204 performs one or more anomaly detection methodologies resulting in the identification of an anomaly in the time-series metric to which the alert 1210 corresponds and identified in the data transmission 1216. Example anomaly detection methodologies include are discussed below at least with reference to FIGS. 14-16.

Upon detecting the anomaly, the RCA logic 1204 determines a time range for which to perform the RCA. For example, if an anomaly, e.g., a point at which a metric exceeds a threshold, is detected to have occurred at 12:32 μm, Tuesday, Jan. 28, 2025, the underlying (root) cause may have, and likely did, begin prior to that time. Additional events contributing to or resulting from the root cause may have occurred after that time. Thus, the RCA logic 1204 determines a time window for the RCA that typically surrounds the time corresponding to the detected anomaly (“anomaly time window”). For example, a 10 minute window may be selected comprising 5 minutes immediately prior to the time of the detected anomaly and 5 minutes immediately following the time of the detected anomaly. In some instances, the RCA logic 1204 may utilize a predetermined time window for all anomalies with the time of the detected anomaly being the midpoint of the time window. In other instances, the RCA logic 1204 may select a time window that is dependent on the type of anomaly detected. For example, a detected drift (anomaly) may have a first window with a time of a first occurrence where data deviates from expected behavior being the midpoint of the first window. Additionally, a detected sudden spike in values (anomaly) followed by a quick return to normalcy may have a second window with the first occurrence where data deviates from expected behavior being the midpoint of the first window, where the first window is longer than the second window to account for the difference in data (traces/logs) needed to detect a root cause of a drift compared to that needed to detect a root cause of a sudden spike.

Based on the detected anomaly and a determined time window, the RCA logic 1204 retrieves traces and/or logs generated by components within the user's environment for the anomaly time window. As used herein, logs may refer to text-based records of events, errors, system activity, etc. Logs may be generated by various components of a user's environment such as an operating system, applications processing on a networking device, a network device itself, security tools monitoring a network device, etc. Examples of logs may include syslogs (Linux operating system (OS)), event logs (Windows OS), error logs, warnings, debug messages, failed login attempts, firewall activity, etc. As used herein, traces may refer to end-to-end tracking of a request across distributed services. Typically, distributed applications generate traces such as microservices or APIs. One example of a trace includes the data generated by a set of microservices processing a user request to open a webpage, where events across the distributed services deployed to carry out the user request are linked via a trace ID.

In some instances, the RCA logic 1204 generates a search query 1218 that is provided to a data intake and query system 1208, that when executed by one or more processors, returns a set of logs and/or traces 1220. The RCA logic 1204 may also query the data intake and query system 1208 for the time-series metric constrained by anomaly time window (“time-series segment 1222”). As one technical advantage provided by the RCA logic 1204, by determining an anomaly time window based on a detected anomaly, the RCA logic 1204 may retrieve a small time-series segment 1222 implicated by the alert 1210 that is targeted to the time frame surrounding the detected anomaly. In other implementations or when a time-series metric generally is provided to an LLM, the prompt is consumed by the time-series metric leaving little room for additional context and often confusing due to the overwhelming amount of normal (benign) data that is often irrelevant to the RCA. The RCA logic 1204 then generates a prompt 1224 that includes instructions for the LLM 1206 to perform an RCA on the time-series segment 1222 and the retrieved logs/traces 1220. The prompt 1224 is then provided to LLM 1206.

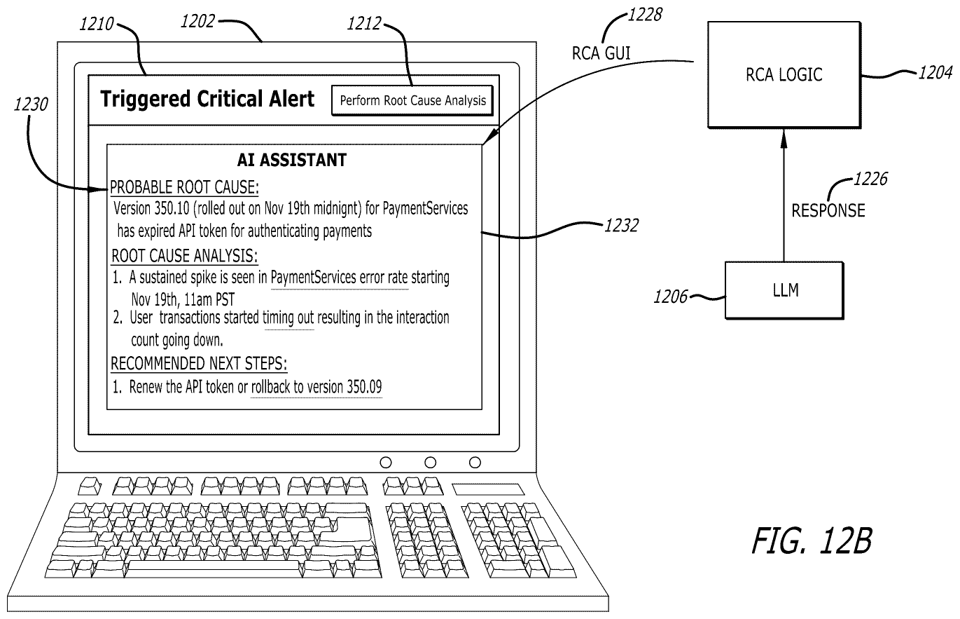

Referring now to FIG. 12B and continuing the operational flow that began in FIG. 12A, the LLM 1206 processes the prompt 1224 and provides a response 1226. In some implementations, the LLM 1206 may be a closed-source LLM or an open-source LLM. A closed-source LLM should be understood to be a language model whose underlying code, architecture, training data, and weights are proprietary and not publicly available, with an example being OpenAI's GPT-4. An open-source LLM should be understood to be a language model copies of which are available for download by the public, where the underlying code, architecture, and pre-trained weights of such copies may be accessed and modified. Examples of open-source LLMs include Mistral 7B, GPT-NeoX, and FLAN-T5. In some examples, the LLM 1206 and the RCA logic 1204 may process on the user's networking device. In other examples, the LLM 1206 may be deployed in cloud computing resources. As will be discussed below in connection with FIG. 13, the LLM 1206 may be an orchestration agent that is formed of an LLM. The RCA logic 1204 receives the response 1226 and generates a graphical user interface (GUI) that displays of the RCA (RCA GUI) 1228. The GUI may take the form of a chat interface 1230 and display content related to one of: a possible root cause, a root cause analysis, and one or remediation steps (“RCA results 1232”). In some instances, the generation of the RCA 1228 may include revising a previously displayed GUI to include the response 1226.

FIG. 13 is a conceptual illustration of performance of an automated root cause analysis through deployment of an artificial intelligence (AI) assistant that includes root cause analysis (RCA) logic, an orchestration agent, a plurality of sub-large language model (LLMs), and a plurality of logic modules in accordance with various embodiments of the disclosure. FIG. 13 illustrates a networking environment 1300 that includes a networking device 1302 in communication with an artificial intelligence (AI) assistant 1304. The AI assistant 1304 is shown to comprise an RCA logic 1306 and an orchestration agent 1308 that is configured to invoke one or more sub-LLMs 1310 (and specifically the root cause analysis sub-LLM 1310A for performing an RCA) and/or one or more logic modules 1312 such as the logs/trace analysis logic module 1312A and the time-series analysis logic module 1312B.

The operational flow of FIG. 13 may begin with an alert 1314 being generated and displayed on a display screen of the network device 1302, where the alert corresponds to a time-series data set the values of that have triggered the alert 1314. The alert 1314 is shown to include a UI component 1316 that corresponds to a “1-click RCA” feature as discussed herein and is configured to receive user input 1318. Upon receipt of the user input 1318, a time-series identifier 1320 or other information identifying a time-series data set corresponding to the alert 1314 is provided to the RCA logic 1306 of the AI assistant 1304. The RCA logic 1306 performs the operations discussed in detail throughout the disclosure resulting in the generation of a prompt 1322 that is provided to the orchestration agent 1308 instructing the orchestration agent 1308 to perform an RCA on the time-series data set indicated by the time-series identifier 1320.

In some examples, the orchestration agent 1308 may be a large language model that is configured to parse the prompt 1322, determine a plan for answering the prompt 1322, invoke one or more specialized agents 1310 (“sub-LLMs”) and/or one or more logic modules 1312, and reason with results provided by specialized agents 1310 and/or the logic modules 1312. For example, a prompt may provide instructions to perform a root cause analysis on a particular issue (e.g., of that an alert) and be provided a time-series segment, traces/logs, and optionally other contextual information to specialized instructions. In such an example, the orchestration agent 1308 may process the prompt and plan how to answer the question. The orchestration agent 1308 may determine that a plurality of steps need to be followed including invoking the sub-LLM 1312A to analyze traces/logs and invoking the sub-LLM 1312B to analyze the time-series segment. As a subsequent step, the orchestration agent 1308 may then need to synthesize the results of the sub-LLMs 1312 and reason for the possible root cause, which may possibly include invocation of additional logic modules.

In various examples, the orchestration agent 1308 is formed of or includes a language model. The language model may be a closed-source LLM or an open-source LLM. A closed-source LLM should be understood to be a language model whose underlying code, architecture, training data, and weights are proprietary and not publicly available, with an example being OpenAI's GPT-4. An open-source LLM should be understood to be a language model copies of which are available for download by the public, where the underlying code, architecture, and pre-trained weights of such copies may be accessed and modified. Examples of open-source LLMs include Mistral 7B, GPT-NeoX, and FLAN-T5. To note, the term “LLM” as used herein may refer to a closed-source LLM or an open-source LLM as discussed above (regardless of whether the LLM is an orchestration agent or part of an AI assistant).

The orchestration agent 1308 includes a function calling feature that is capable of selecting and invoking the sub-LLMs 1310 and/or one or more logic modules 1312 to perform a task indicated in the prompt. The orchestration agent 1308 obtains knowledge of the sub-LLMs and the available logic modules from a list of sub-LLMs and a list of logic modules, which each list providing a function description for each sub-LL or logic module. The orchestration agent 1308 may then parse a prompt, determine what sub-LLM(s) and/or logic modules need to be called to obtain or generate the answer to the prompt, and then invoke one or more sub-LLMs and/or logic modules with the necessary parameters generated by the orchestration agent 1308. For a complicated task, invocation of a plurality of logic modules or sub-LLMs may be chained together to obtain or generate a final answer. As discussed below, the orchestration agent 1308 may advantageously invoke a sub-LLM to handle a task, which in turn invokes one or more logic modules. As a result, various technical benefits arise including increased efficiency, improved processing latency, and reduced resource cost. Specifically, when the orchestration agent 1308 invokes a sub-LLM 1310, the orchestration agent 1308 is in effect delegating to the invoked sub-LLM 1312 as the invoked sub-LLM 1312 may invoke one or more logic modules.

While an LLM-based orchestration agent is discussed throughout the disclosure, the orchestration agent 1308 may also be formed of or include a decision tree that influences or determines which logic modules to use. In such examples, the orchestration agent 1308 may also rely on an LLM to generate text that explains the results of the logic modules called, e.g., as a natural-language response or generate one or more graphical interfaces such as charts or plots.

As used herein, the term “logic module” may refer to an external utility or software component that is provided to enhance the capabilities of the orchestration agent 1308. For example, a logic module may be a software module that is executable by the orchestration agent 1308 through an Application Programming Interface (API) call such that the execution of the logic module enables the orchestration agent 1308 to perform a specific task that is outside the scope of the intrinsic functionalities of the orchestration agent 1308 (e.g., of the language model forming the orchestration agent 102). In some instances, a logic module may also be another language model (also referred to as a specialized agent or “sub-LLM,” because this sub-LLM is invoked specifically to aid the orchestration agent 1308 in generating a high quality response to a user input question), which may focus on a more specialized task and may receive a different prompt instruction from the orchestration agent 1308 than that received from the user directly, where the second prompt is created by the orchestration agent 1308, and typically computes on a subcontext (e.g., not the full context available to the orchestration agent 1308).

As discussed above, the orchestration agent 1308 may advantageously invoke a sub-LLM to handle a task, which in turn invokes one or more logic modules. As a result, various technical benefits arise including increased efficiency, improved processing latency, and reduced resource cost. Specifically, when the orchestration agent 1308 invokes a sub-LLM 1310, the orchestration agent 1308 is in effect delegating to the sub-LLM 1310 to execute a prompt, e.g., to perform a root cause analysis and subsequently invoke the logic modules 1312A-1312B.

Following evaluation of the prompt 1322 by the orchestration agent 1308 and any of the sub-LLMs 1310 and/or the logic modules 1312 invoked thereby, a response 1324 is provided to the RCA logic 1306, which generates an RCA GUI 1326 that is displayed on the display screen of the network device 1302 as discussed here. For example, the RCA GUI 1326 may be displayed in a chat interface enabling the user to continue interaction with the AI assistant 1304. Additionally as discussed herein, the AI assistant 1304 may initiate remediation measures as described herein.

FIG. 14 is a flowchart illustrating a first example process of operations for performing an automated root cause analysis according to an implementation of the disclosure. Each block illustrated in FIG. 14 represents an operation in the process 1400 performed by, for example, an RCA logic and an LLM as discussed through the disclosure. It should be understood that not every operation illustrated in FIG. 14 is required. In fact, certain operations may be optional to complete aspects of the process 1400. The process 1400 begins with receiving user input corresponding to instructions to perform a root cause analysis (RCA) on a metric or key performance (KPI) associated with a time-series metric (block 1402). As an example, the user input may be received as part of a “1-click RCA” including activation of a UI component provided on an alert such as that of FIG. 11-12B.

The process 1400 continues with the performing pre-processing on the time-series metric associated with the alert (block 1404). The pre-processing may result the detection of an anomaly and the selection of an anomaly time window, where a set of traces and/or logs are retrieved such as from a data intake and query system. The prompt is provided to a LLM and includes instructions to provide an RCA based on a segment of the metric time-series, where, optionally, the prompt includes the segment of the time-series metric, any traces, or any logs (block 1406). A response is received from the LLM, and a graphical user interface (GUI) is generated that illustrates an RCA performed by the LLM (block 1408).

The RCA may outline a set of one or more remediation measures, where the process 1400 may optionally include performance of one or more of the remediation measures (block 1410). The remediation measures are typically dependent on the root cause of the issue that triggered the alert. For example, when the root cause relates to a security measure such as unusual login attempts (such as brute-force login attempts, unauthorized access attempts, receipt of malware/phishing emails or network communications, data exfiltration, etc.) remediation measures may include blocking suspicious internet protocol (IP) addresses through a firewall or security information and event management (SIEM) system, requiring multi-factor authentication (MFA) for a subset of users, quarantining a subset of users' systems, accounts, or machines (such as preventing network traffic to or from a system, account, or machine believed to be affected), deleting or locking files suspected to be malicious, attempting to claw back an email or network communication, moving an email within a user's mail client to a spam or junk folder (and optionally notifying the user), perform an anomaly detection process involving processing of a file (email, attachment, download, script, etc.) considered suspicious or malicious within a virtual environment (e.g., sandbox analysis), etc.

When the issue relates to network performance or latency issues, the remediation measures recommended or automatically performed may include rerouting network traffic (e.g., through SD-WAN or load balancers), throttling or dropping suspicious traffic at firewalls, blocking suspicious or malicious IP address or domains at a firewall or SIEM system, restarting or reconnecting with unresponsive network services (e.g., VPN services, DNS servers, or proxies), etc. Additional remediation measures recommended or automatically performed may include automatically scaling (up or down) allocated compute resources to a particular accounts through provisioning or terminating EC2 instances, VMs, etc., deleting temporary files or log archives from a machine, reassigning workloads between nodes, reverting to a prior software version, etc.

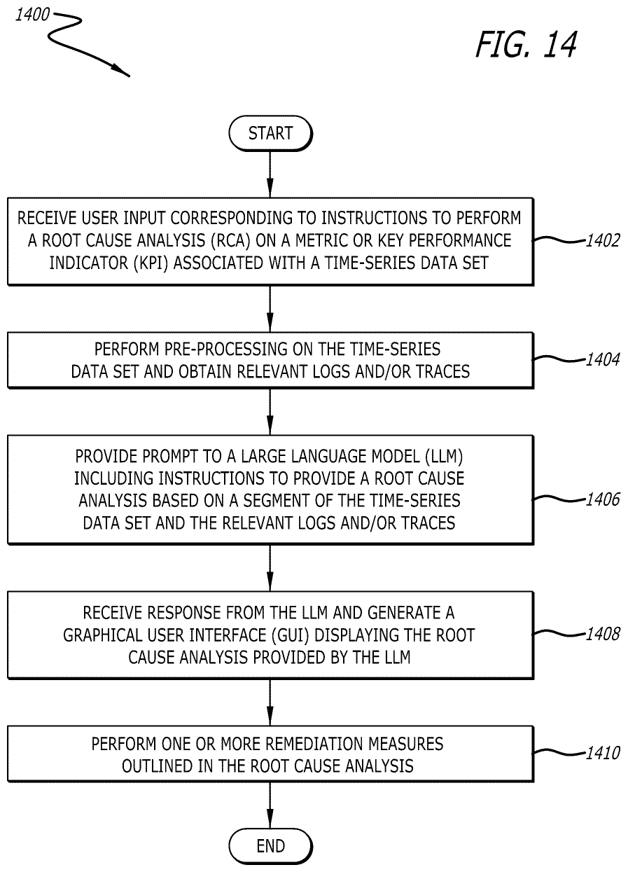

FIG. 15 is a flowchart illustrating a second example process of operations for performing an automated root cause analysis according to an implementation of the disclosure. Each block illustrated in FIG. 15 represents an operation in the process 1500 performed by, for example, an RCA logic and an LLM as discussed through the disclosure. It should be understood that not every operation illustrated in FIG. 15 is required. In fact, certain operations may be optional to complete aspects of the process 1500. The process 1500 begins with the generation of an alert in a graphical user interface (GUI) that includes a user input (UI) component configured to receive user input corresponding to selection of an automated root cause analysis (RCA) (block 1502). Following receipt of user input activating the UI component thereby initiating the automated RCA, logic, such as any of the implementations of the RCA logic disclosed through the disclosure, obtains a time-series data set corresponding to a metric or a key performance indicator (KPI) on which the alert is based (block 1504). The RCA logic then performs one or more anomaly detection methodologies resulting in detection of an anomaly in the time-series data set (block 1506). A time window may then be determined by the RCA logic, which indicates a time window during which the root cause likely began and developed (“anomaly time window”) and may be dependent on the type of anomaly detected as discussed above. The RCA logic may then perform a log/trace search constrained by the anomaly time window (block 1508). In some instances, performance of the log/trace search may include querying one or more datastores for logs and/or traces generated by components of a user's system, account, or machine during the anomaly time window. In some instances, the query may search for logs or traces that correspond to certain components that are associated with the time-series metric. In other instances, a larger net may be cast that searches for logs/traces beyond a single user's system, account, or machine and searches for logs and/or traces generated by users' systems, accounts, or machines within a department within an enterprise (or more broadly any subset of users within an enterprise), or across an entire enterprise. In some examples, the log/trace search may involve the generation of a search query, such as according to a particular syntax of a programming code language such as Search Processing Language typically used by Splunk, Inc., wherein the search query is executed by a data intake and query system, which is discussed below.

Based on the alert, the time-series data set, the anomaly time window, and any retrieved logs and/or traces, the RCA logic generates a prompt that instructs a LLM to perform a root cause analysis of an issue indicated by the alert (block 1510). The prompt is then provided to an LLM, and a response is received that includes an RCA result (block 1512). The RCA logic generates an RCA GUI that displays the RCA provided by the LLM (block 1514). As discussed throughout the disclosure, the RCA GUI may be displayed on a display screen of a network device of a user, such as in a chat interface associated with an AI assistant; however, other GUI variations have been contemplated that do not require display within a chat interface. The process 1500 may further include performance of one or more remediation measures outlined in the RCA automatically or in response to user feedback (block 1516), which may include user approval of initiation of a remediation measure or user selection of one or more remediation measures to be performed.

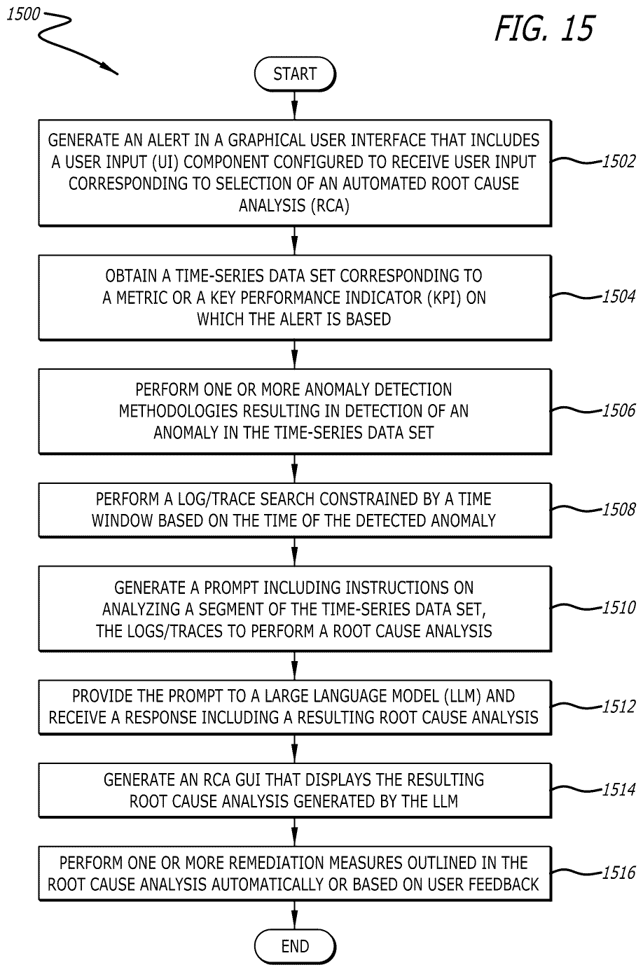

FIG. 16 is a logical representation of a root cause analysis (RCA) logic in accordance with various embodiments of the disclosure. In the example shown in FIG. 16 a networking device 1600 includes one or more processors 1602 that is communicatively coupled to a communication interface 1604 and non-transitory storage medium (storage) 1606, which may be non-transitory computer readable medium. The storage 1606 may have stored thereon logic, e.g., in the form of computer-executable instructions, that, when executed by the processor 1602, cause the processor 1602 to perform the methods described herein. Examples of such storage include non-transitory computer-readable mediums, such as a magnetic or optical storage disk or a flash or solid-state memory, from which executable instructions can be loaded into the memory of the networking device 1600 for execution. The term “non-transitory” refers to retention of the program code by the computer-readable medium while not under power, while volatile or “transitory” memory or media requires power in order to retain data.

As used herein, one implementation of a networking device may be a server device that has a memory for storing program code instructions and a hardware processor for executing the instructions. An alternative implementation of the networking device may be a personal computing or processing device such as a laptop or desktop computer, a tablet, a mobile device, etc. The networking device can include other physical components, such as a network interface or components for input and output. The storage 1606 may include components that collectively may be referred to as an RCA logic 1608, which includes an anomaly detection logic 1610 configured to perform one or more anomaly detection methodologies such as baseline deviation such as detection of spikes/drops in a time-series data set compared to normal or expected values, drift/trend-based anomaly detection such as detecting a gradual change in values of a time-series data set over a time, outlier detection (e.g., through application of machine-learning models), forecasting anomaly detection including detecting deviations in predicted values, detection of categorical anomalies in a time-series data set, security anomaly detection including detection of suspicious/malicious logins, data exfiltration, etc. The RCA logic 1608 may further include a machine learning (ML) model data store 1612 that is accessible by the anomaly detection logic 1610 when applying an ML model in an anomaly detection process.

The RCA logic 1608 further includes a time range logic 1614 that is configured to select an anomaly time window as discussed above. For example, the time range logic 1614 may select a default length for the anomaly time window with the detected anomaly being the midpoint in the window. In other instances, the length of the anomaly time window may be dependent on the type of anomaly detected. In such instances, the time range logic 1614 receives the detected anomaly or information indicative of a type thereof and selects a length for the anomaly time window based thereon. Subsequently, the time range logic 1614 applies the length of the anomaly time window to the time-series data set based on the time of the detected anomaly to select the anomaly time window.

The RCA logic 1608 further includes a search query generation logic 1616 that is configured to generate search queries to retrieve a time-series data set corresponding to an alert from which an RCA was initiated (or to which an RCA is being performed in instances when the RCA is not triggered directly from an alert). The search query generation logic 1616 may be configured to generate search queries in various programming languages, especially search query languages such as Search Processing Language (SPL) and SignalFlow as used by applications and products provided by Splunk, Inc. In some instances, the search queries may be generated through populating template queries. In other instances, the search query generation logic 1616 may instruct an orchestration agent to assist in generation of a search query, which the orchestration agent is illustrated in FIG. 13.

The RCA logic 1608 further includes a prompt generation logic 1618 that is configured to generate prompts for transmission to an LLM as discussed herein, where the LLM may be a standalone LLM or may be an orchestration agent that is configured to invoke sub-LLMs and/or logic modules to complete tasks requiring specific expertise. Additionally, the RCA logic 1608 may include a GUI generation logic 1620 that is configured to generate graphical user interfaces that display results of an RCA. Example GUIs include a chat interface that may accompany an AI assistant, network communications such as emails, text messages, pop-ups or other alerts, etc. The GUI generation logic 1620 may similarly generate display modules that appear as part of a dashboard, such as those at least partially illustrated in FIGS. 11 and 17A-18. Additionally, the RCA logic 1608 may also include a remediation logic 1622 that is configured to initiate or carry out any of the remediation measures discussed here including interfacing with network components such as firewalls, routers, proxies, mail clients, virtual machines, etc.

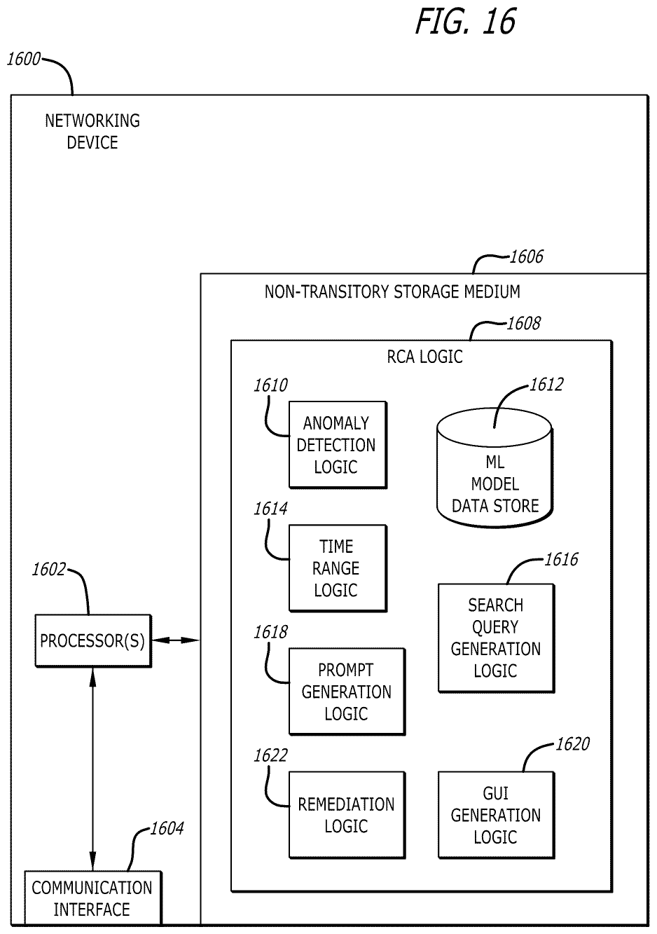

FIGS. 17A-17B provide an illustrative operational flow in the performance of an automated root cause analysis through deployment of a large language model (LLM) following receipt of user input to a chat interface in accordance with various embodiments of the disclosure. The operational flow of FIGS. 17A-17B is similar to that discussed with respect to FIGS. 12A-12B in that user input is received that initiates an RCA. While the operational flow of FIG. 12A-12B correspond to receipt of user input through the activation of a UI component 1212 on an alert indicative of an issue with a particular time-series data set or a KPI that corresponds to a particular time-series data set, the operational flow of FIGS. 17A-17B includes the receipt of user input to a chat interface of an AI assistant, wherein the user input selects a UI component within the chat interface that is related to a selected component within the display screen.

More specifically, FIGS. 17A-17B illustrate a networking environment 1700 that is comprised of a networking device 1702, an RCA logic 1704, an LLM 1706, and optionally, a data intake and query system 1708. The operational flow of FIG. 17A illustrates the operational flow of data transmission and logical operations performed beginning with the initiation of an RCA in response to the receipt of user input, processing of information related to a selected icon, retrieval of necessary data from storage, and generation of a prompt for an LLM. The operational flow of FIG. 17B continues the operational flow of data transmission and logical operations shown in FIG. 17A by illustrating data transmission from the LLM to the RCA logic in response to the prompt and generation of a GUI displaying results of the processing by the LLM.

Referring now to FIG. 17A, the operational flow begins when user input is received corresponding to selection of an icon 1712 or other aspect of a dashboard, which is then followed by receipt of additional user input corresponding to selection of a UI component 1716, e.g., a selectable button, displayed within a chat interface 1714, e.g., of an AI assistant. The subsequent user input may correspond to activation of the UI component 1716 that is linked to the selection of the icon 1712. For example, the AI assistant may generate the UI component 1716 upon selection of the icon 1712, which provides the user a simple way to perform a “1-click RCA” on the metrics of the selected icon 1712. For example, the dashboard shown in FIG. 17A may correspond to an overview of an operational status of components of a particular service being monitored by an observability product as referenced above. For example, the overview may provide a visual of operations performed by microservices such as a checkout service, a payment service, and a payment with metrics indicated for each. The monitoring of the services may indicate that one microservice is performing anomalously, e.g., slower than expected. The user may desire to select that icon and see additional details on the service or microservice (or transaction or other occurrence or component illustrated on the display, where such is associated with one or more time-series data sets). An AI assistant may be automatically triggered to provide the UI component 1716 enabling the user to provide a single user input to initiate a RCA on the selected icon to understand why the service or component is performing anomalously.

As discussed above with reference to FIG. 12A, the activation of the UI component 1716 through user input may result in a data transmission 1718 operation to the RCA logic 1704, where the data transmission may include certain information pertaining to the service, microservice, component, etc., represented by icon 1712 such that an identifier of a time-series metric to which the icon 1712 pertains, a time range illustrated on the display (e.g., possibly a time filter selected by a user), a monitored KPI to which the time-series metric pertains (contributes), and optionally, tokens or user credentials enabling the RCA logic 1704 to access certain datastores or databases storing the time-series metric and traces/logs that may be relevant to the RCA.

The RCA logic 1704 receives the data transmission 1718 initiated by the user input and initiates performance of operations including anomaly detection methodologies, trace/log searches, prompt generation, and transmitting the prompt to the LLM 1706. More particularly, in some implementations, upon receiving the data transmission 1718, the RCA logic 1704 may perform one or more anomaly detection methodologies resulting in the identification of an anomaly in the time-series metric to which the icon 1712 corresponds and identified in the data transmission 1718. Example anomaly detection methodologies include are discussed below at least with reference to FIGS. 14-16.

Following detection or identification of an anomaly through any of various anomaly detection methodologies such as those discussed with reference to FIGS. 14-16, the RCA logic 1704 determines a time range for which to perform the RCA, e.g., an anomaly time window for the RCA as discussed above. Based on the detected anomaly and a determined anomaly time window, the RCA logic 1704 retrieves traces and/or logs generated by components within the user's environment for the anomaly time window.

In some instances, the RCA logic 1704 generates a search query 1720 that is provided to a data intake and query system 1708, that when executed by one or more processors, returns a set of logs and/or traces 1722. The RCA logic 1704 may also query the data intake and query system 1708 for the time-series metric constrained by anomaly time window (“time-series metric segment 1723”). The RCA logic 1704 then generates a prompt 1724 that includes instructions for the LLM 1706 to perform an RCA on the time-series segment 1723 and the retrieved logs/traces 1722. The prompt 1724 is then provided to LLM 1706.

Referring now to FIG. 17B and continuing the operational flow that began in FIG. 17A, the LLM 1706 processes the prompt 1724 and provides a response 1726. In some implementations, the LLM 1706 may be a closed-source LLM or an open-source LLM. In some examples, the LLM 1706 and the RCA logic 1704 may process on the user's networking device. In other examples, the LLM 1706 may be deployed in cloud computing resources. As discussed above in connection with FIG. 13, the LLM 1706 may be an orchestration agent that is formed of an LLM. The RCA logic 1704 receives the response 1726 and generates a graphical user interface (GUI) that displays of the RCA (RCA GUI) 1728. The RCA GUI 1728 may be a portion of the chat interface 1714 and display content related to one of: a possible root cause, a root cause analysis, and one or remediation steps (“RCA results 1730”).

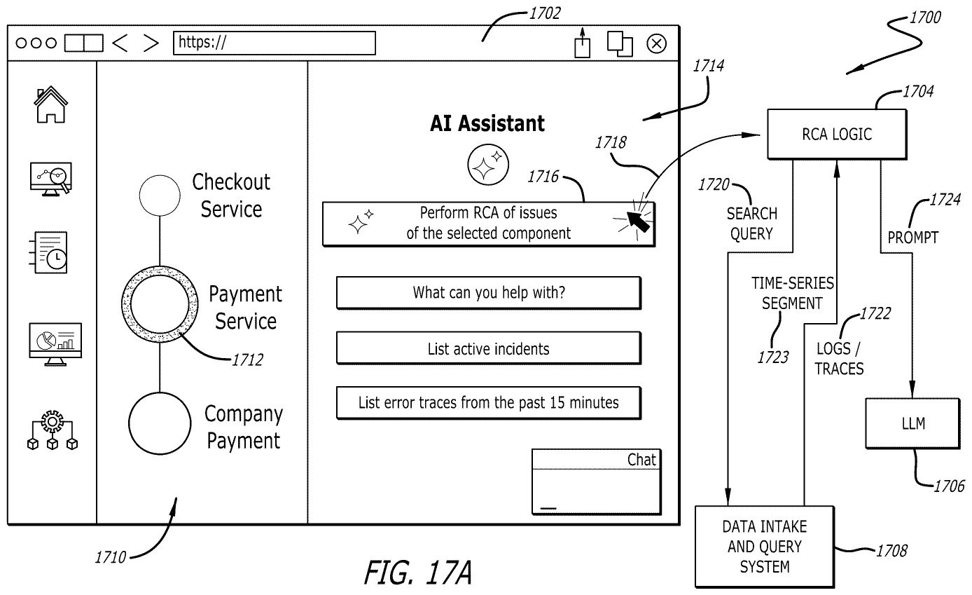

FIG. 18 provides an illustrative operational flow in the performance of an automated root cause analysis through deployment of a large language model (LLM) following receipt of user input to a chat interface including acquisition of context from a displayed webpage in accordance with various embodiments of the disclosure. The operational flow of FIG. 18 is similar to that discussed with respect to FIGS. 17A-17B in that user input is received that initiates an RCA. While the operational flow of FIG. 17A-17B correspond to receipt of user input through the activation of a UI component 1716 that was generated based on or associated with a selected icon 1712, the operational flow of FIG. 18 includes an AI assistant 1803 configured to automatically obtain context of a webpage 1810 displayed with a web browser 1802 to enable a user to provide user input to a UI component 1814 of a chat interface 1812, where the UI component 1814 recites text similar to “Perform an RCA of issues on this page.” In such an example, the AI Assistant 1803 may receive an indication 1816 that the user input was received on the UI component 1814, which initiates a context acquisition process performed by a context acquisition logic 1805 of the RCA logic 1804. The context acquisition process may include retrieving the uniform resource locator (URL) 1818 of a webpage rendered on a display screen of a networking device, where the URL 1818 includes terms corresponding to the data rendered on the webpage 1810, e.g., an overview of the operability of certain services or microservices and/or network components.

Thus, differently than the operational flow of FIGS. 17A-17B that requires a user to select an icon 1712, which gives the AI assistant an indication as to a time-series dataset on which to perform the RCA, the operational flow of FIG. 18 includes a context acquisition logic 1805 within the RCA logic 1804 that retrieves the URL 1818 of the displayed webpage 1810, parses the URL 1818 to extract terms such as filters applied, an environment in which the displayed data pertains, a service or component displayed, and retrieves one or more time-series data sets pertaining thereto. The RCA logic 1804 may then follow the same process in performing an RCA discussed of performing one or more anomaly detection methodologies, determining an anomaly time window, generating a search query 1820, retrieving relevant traces/logs 1822 and a time-series segment 1824 (e.g., from a data intake and query system 1808), generating a prompt 1826 and providing the prompt 1826 to the LLM 1806. While not illustrated explicitly in FIG. 18, the LLM 1806 returns a response to the RCA logic 1804, which generates an RCA GUI for display within the chat interface 1812 of the AI assistant in the same manner as was discussed with respect to FIG. 17B.

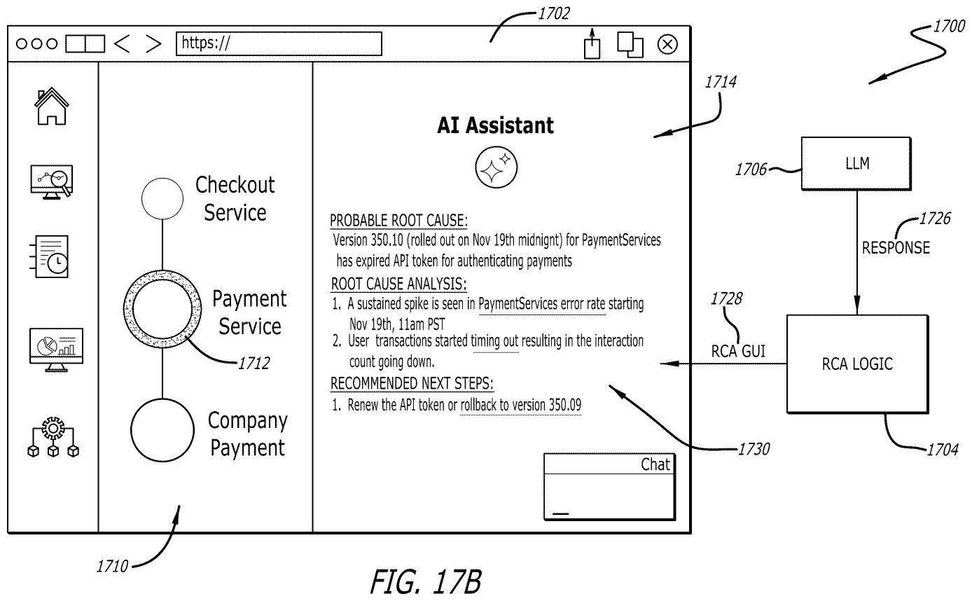

FIG. 19 is a block diagram showing a system 1900 employing the one-click root cause analyzer in accordance with various embodiments of the disclosure. The system 1900 includes an APM tool 1910, an observability tool 1920, a metadata acquisition tool 1930, an RCA logic 1940 and a GUI 1950. The system 1900 may include more or less than the above components. The APM tool 1910 may be an application, or a software module, configured to monitor and analyze the performance of other APIs or applications. It may provide a wide range of metrics, including response times, latency, throughput, error rates, resource usage, detailed error analysis, root cause identification, performance profiling, and others. The APM tool 1910 may include interfaces to other modules so that its information or results may be shared or used by other modules.

The observability tool 1920 may be an application, a program, or a software module that is configured to collect, analyze, and visualize data in a network environment. It may be available in the chatbot used with the AI Assistant. The observability tool 1920 may produce results from correlating insights, user behavior analytics, and integration other tools. The observability tool 1920 may obtain telemetry data used for diagnosis or RCA. The telemetry data include logs, metrics, and traces. Logs are records of events including timestamps, durations, and the context related to the events. Metrics are values measured in a dynamic environment. The metrics may represent the number of failures, the number of successful connections, the number of requests, or any other measurements that are related to events or performance. Traces show the path of the progression of an event from the start to the end. Tracing allows the user to follow what's going on as an event goes through its journey. One type of useful tracing is distributed tracing which tracks a single request by collecting and analyzing data on every interaction with every service the request touches. This is particularly helpful in troubleshooting because it allows one to recognize issues with each interaction and may identify the sources of errors. The observability tool 1920 provides these data to the RCA logic 1940 so that it can synthesize with other information, data, or result to generate a complete picture of what's going on.

The metadata acquisition tool 1930 acquires metadata that are associated with the event that triggers the one-click request. The acquired metadata may provide context to guide the RCA logic 1940 in the proper direction. This may result in fast and accurate diagnosis. The metadata acquisition tool 1930 may extract metadata from the web page the user is on at the time the triggering event occurs.

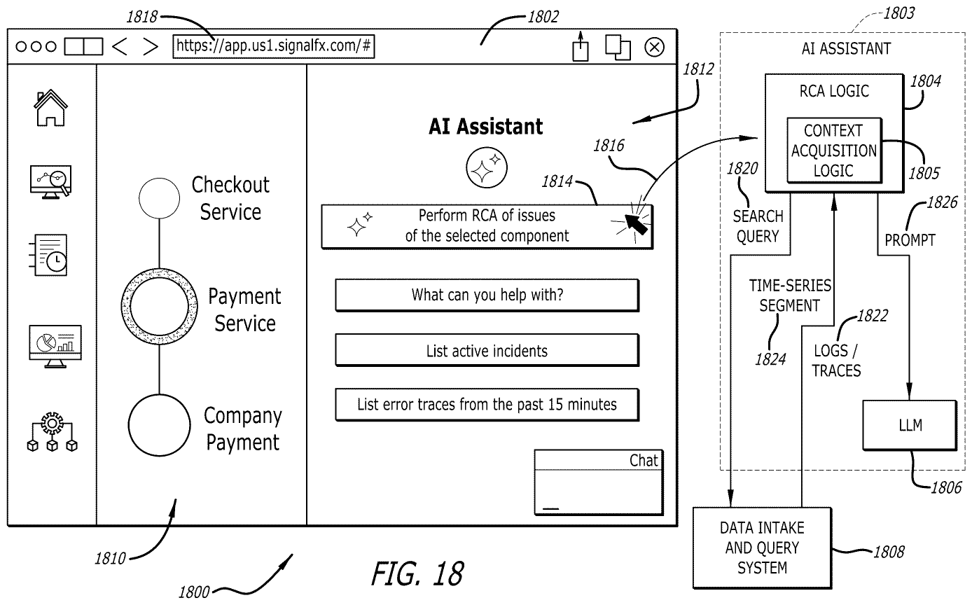

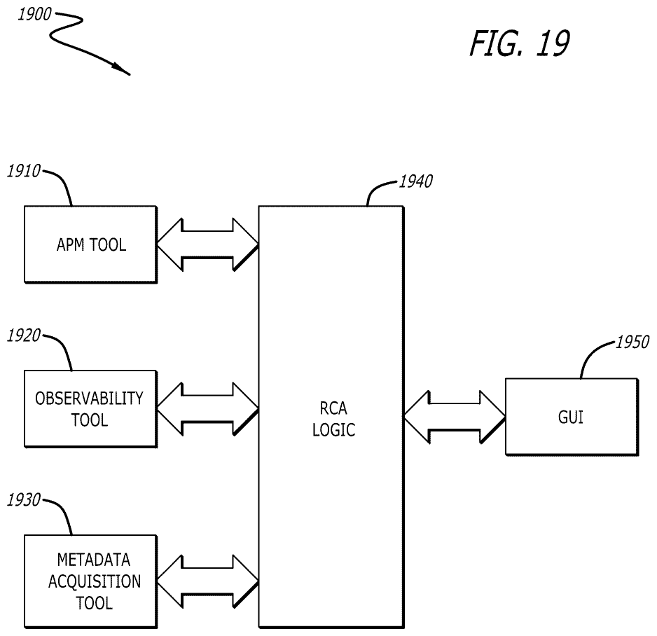

The RCA logic 1940 performs operations comprising the one-click RCA. In particular, the RCA logic 1940 collects information, data, and measurements from the APM tool 1910, the observability tool 1920, and the metadata acquisition tool 1930, and follows a well-defined troubleshooting path to find the root cause of the event that triggers the alert. FIGS. 20-21 show details of the processing blocks within the RCA logic 1940. In various embodiments, the RCA logic 1940 may be implemented by an AI tool such as a rule-based system and/or a machine learning system. FIG. 21 describes such an implementation.

The GUI 1950 provides all the interfaces to the user and among various components in the system. It may show the GUI display 1810 shown in FIG. 18. It may allow the user to interact with the LLM that implements the RCA logic 1940 during training or during fine-tuning. It may allow conversion of the button clicking action on the panel 1150 into an inquiry to be sent to the LLM. It may allow the user to interact with the rule-based system that implements the RCA logic 1940 during knowledge acquisition stage.

The path of finding the root cause of a problem represented by the triggering event may go through several stages. In most cases, this path traverses a hierarchical tree of payloads that provide the operations associated with a process or a service. As the troubleshooting travels through this path, the problems size gets smaller and smaller because the process eliminates candidates that may contribute to the problem. At the end of the journey, the path converges to the correct root cause when the problem is correctly identified, and solutions are recommended.

FIG. 20 is a flow diagram showing an example sequence of functions of the RCA logic 1940 in accordance with various embodiments of the disclosure. To help understand this sequence, a legend 2005 describes the notations used for the sequence. The notations include identifiers for a scope of the problem. Examples include: (a) payment service, (b) time, (c) environment, (d) error, (e) application code, (f) 401 authorization failure, (g) deployment of version 9.2, and (h) rollback to version 9.1. These notations are only examples of a payment service in a service software system.

In this example, there are 6 levels: a L1 level 2012, a L2 level 2022, a L3 level 2032, a L4 level 2042, a L5 level 2052, and a L6 level 2062. Each level is shown in a circle. The size of the circle represents the scope of the problem. The bigger the size, the larger the scope. Each scope corresponds to a combination of service components that have been identified. The more service components that are identified, the smaller the scope of the problem. The sequence in the RCA logic 1940 has an increasing number of identified service components. The levels L1, L2, L3, L4, L5, and L6 correspond to the identification sets 2014, 2024, 2034, 2044, 2054, and 2064, respectively.

The sequence includes six operations 2010, 2020, 2030, 2040, 2050, and 2060 corresponding to the six levels 2012, 2022, 2032, 2042, 2052, and 2062, respectively, and the six identification sets 2014, 2024, 2034, 2044, 2054, and 2064, respectively. At the beginning, an alert is generated indicating that the payment service is unhealthy compared to other services in the environment or dashboard. An operation 2010 identifies the “payment service” is unhealthy at a time when other services in the environment are healthy. It is, therefore, not a systemic problem and it appears to be a problem particularized to the payment service. The scope of the problem is the largest because at this point, no cause has been identified and the system can only identify the set 2014 which includes the components (a), (b), and (c) which correspond to the payment service, the time, and the environment.

The next step is to determine where the problem occurs. Within the payment service, there are two basic components that may cause problems: error and latency. Since there is a high error rate, the analysis moves to level 2 with an operation 2020 that identifies the impact to Payment Service is “error” (component (d)). The scope 2022 gets smaller than the scope 2012 and the identification set increases by including the component (a) in the set 2024. The analysis then moves to level 3 with the operation 2030 that identifies the impact domain. At this stage under “error,” there are two possible components: application code or underlying infrastructure (infra) component. The analysis checks the report on infrastructure components and finds that all the infra components are healthy. Therefore, the analysis concludes that the cause at this level is the application code (component (e)). The scope 2032 becomes smaller than the scope 2022 and the identification set increases by including the component (e) in the set 2034.

The analysis then moves to the operation 2040 that identifies the likely root cause. At this level L4, the analysis examines the logs and recommends the 401 calls per log/trace analysis. The scope 2042 gets smaller than the scope 2032 and the identification set increases by including the 401 authorization failure error (component (f)) in the set 2044. The analysis next moves to operation 2050 that pinpoints the root cause related to a change event which may have caused the 401 authorization failure error. The scope 2052 gets smaller than the scope 2042 and the identification set increases by including the deployment of version 9.2 (component (g)) in the set 2054.

Finally, the analysis moves to the operation 2060 that recommends the solution. The solution is to restore the previous condition prior to the change event by a rollback to service version 9.1 which correlates to 401 error occurrences based on events and logs. The scope 2062 is smaller than the scope 2052 and the identification set increases by including the rollback to version 9.1 recommendation (component (h)) in the set 2064. The analysis then stops and waits for feedback from the user on the evaluation of the solution. At this level, there is no more possible cause, and the change event may be considered the root cause of the payment service problem at the level L1 2012.

The above sequence illustrates the stages through which the RCA logic 1940 goes. The stages represent a hierarchy of causes and the analysis traverses through the stages by an elimination process to eliminate candidates of cause. This elimination process is aided by obtaining parameters or results from tools such as the APM tool 1910, the observability tool 1920, and the metadata acquisition tool 1930. For example, at level L4, the operation 2040 uses the logs report provided by the observability tool 1920 to identify the 401 failure issue. The sequence of operations and the stages of analysis may be carried out by a rule-based system. Alternatively, the sequence of operations may be carried out by an LLM which has been trained with training data involving the components in the system. The use of these AI tools will be described in FIG. 21.

FIG. 21 is a block diagram showing an example sequence of operations of the RCA logic 1940 according to an implementation. The operations of the RCA logic 1940 include operations 2110, 2120, 2130, 2140, and 2150. At the beginning, when receiving the alert, the RCA logic 1940 starts the operation 2110 which implements the event assessment logic. This operation defines the scope of the problem. The objective is to determine whether the problem lies within the application, the infrastructure, or the network domain. This operation also assesses the impact on users and the dependent services. Based on metadata 2113 acquired by the metadata acquisition tool 1930 and triggering event 2115, the operation 2110 classifies whether the issue is specific to a single application/service (e.g., payment service) or a cross-domain application (e.g., application↔infrastructure↔network). The operation 2110 also determines the scope of the impact. For the user impact, the operation determines if the latency has increased or if there are any errors propagating to the end users. These findings will help the analysis in subsequent operations.

Once the domain is identified, the RCA logic 1940 moves to the operation 2120 to infer the most likely root cause. This operation evaluates telemetry data 2125 including logs, metrics, and traces for anomalies and correlations. The operation also identifies contribution factors such as deployment issues (e.g., recent application version causing resource spikes), infrastructure failures (e.g., high CPU/memory usage, network failures or hardware degradation), and configuration errors (e.g., misguided pipelines or scheduled changes). In addition, the operation 2120 highlights cross-domain impacts. For example, service failures cause network slowdowns.

Next, the RCA logic 1940 moves to the operation 2130 which compares the current issue with past incidents to provide contextual insights. This may be done by searching historical data in historical record 2133 for similar telemetry patterns, error codes, or root causes. This operation may also suggest solutions based on previous successful remediation steps.

Next, the RCA logic 1940 moves to the operation 2140 which performs recommendation logic. The operation 2140 suggests remediation steps 2143 such as rollback, scaling, configuration fixes. In addition, the operation 2140 validates the suggested solutions against historical success rates.

The RCA logic 1940 then moves to the operation 2150 which compiles the feedback data from user validation 2153. This is done by collecting users' evaluation ratings on the RCA results. The collected evaluation data and the steps that lead to the RCA results are collected, organized, and formatted to be used as training data 2155 for a machine learning implementation for better accuracy.

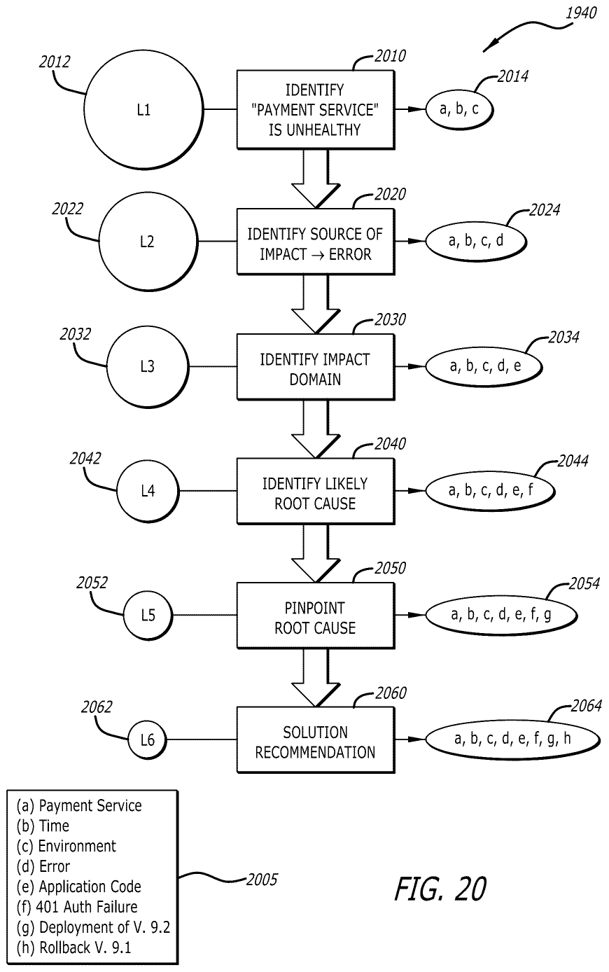

FIG. 22 is a flowchart illustrating a process 2200 of generating a one-click RCA according to an implementation. The process 2200 may include a number of operations or blocks. Not all the operations are needed for the process 2200.

Upon START, the process 2200 receives a user input via a graphical user interface (GUI) requesting an automated generation of a root cause analysis (RCA) corresponding to an alert due to a triggering event (operation 2210). The triggering event is one that causes a problem, a failure, or degraded performance. An example of a triggering event is “a sustained spike in Payment Service error rate at 11:00 AM PST today.” Upon receiving the alert, the user clicks a button on the GUI such as in the alert 1104 in FIG. 11.

Next, the process 2200 obtains context metadata based on the alert (operation 2220). This may be performed by obtaining results from the metadata acquisition tool 1930 in FIG. 19. Then, the process 2200 assesses the trigger event based on at least one of the context metadata, telemetry data, and performance monitoring parameters (operation 2230). This operation may correspond to the operation 2110 (“Event Assessment Logic”) in FIG. 21. Next, the process 2200 infers a root cause (RC) of the triggering event using at least one of a machine learning (ML) application and a rule-based engine (operation 2240). The rule-based engine and the ML application are described in FIG. 21. This operation may correspond to the operation 2120 (“Root Cause Inference”) in FIG. 21.

Then, the process 2200 analyzes a historical record (operation 2250). This operation may correspond to the operation 2130 (“Record Analyzer”) in FIG. 21. The historical record stores past events and operations performed for RCA. Mostly, only successful operations are stored. There are cases that unsuccessful operations are stored with corresponding rating information so that they can be used as training data. Next, the process 2200 recommends an action based on the historical record (operation 2260). This operation may correspond to the operation 2140 (“Recommendation Logic”) in FIG. 21.

Next, the process 2200 compiles feedback data corresponding to the recommended action (operation 2270). This operation may correspond to the operation 2150 (“Feedback Compiler”) in FIG. 21. The feedback data includes user ratings on the recommended action. These ratings may be the ratings after the recommended action is performed and the users observe and evaluate the outcome. The process 2200 is then terminated.

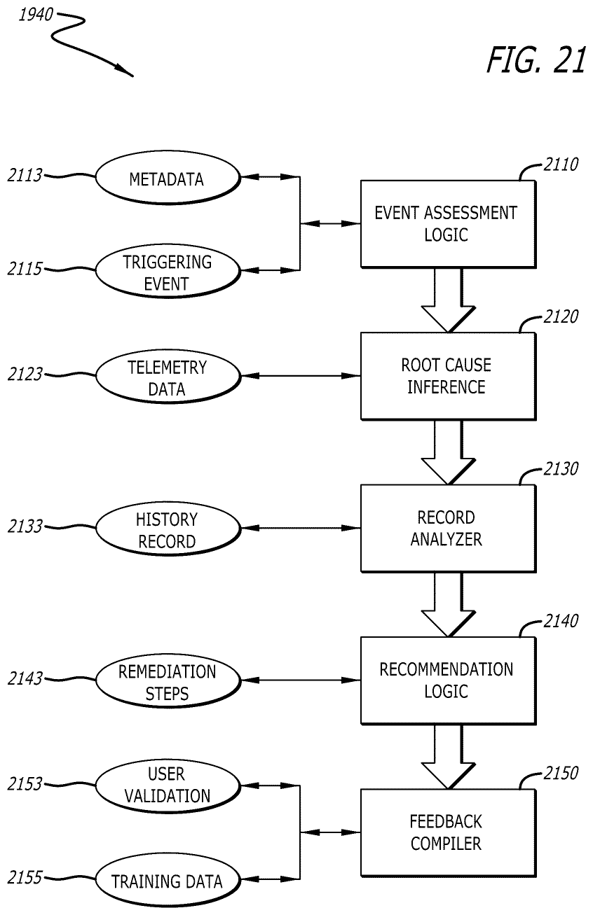

FIG. 23 is a flowchart illustrating the process 2230, shown in FIG. 22, of assessing the triggering event according to an implementation. Upon START, the process 2230 classifies the triggering event to one of a single application or service and a cross-domain application (operation 2310). This operation defines the scope of the problem and helps provide the contour of the possible causes. Next, the process 2230 determines an impact radius of the triggering event (operation 2320). Knowing the impact radius or the scope of the problem area, the RCA may be able to eliminate causes that do not belong to the identified impact. The process 2230 is then terminated.

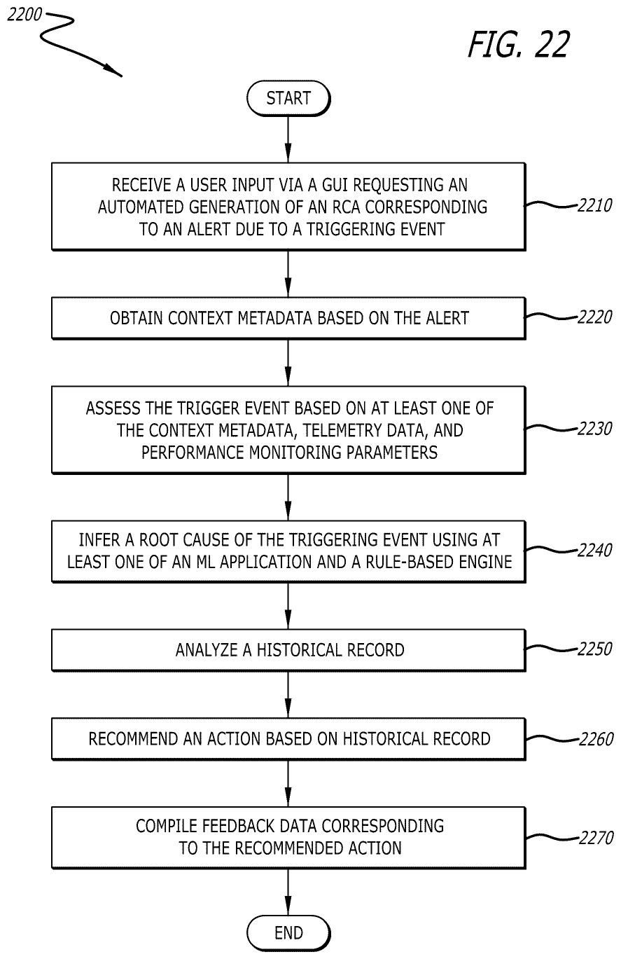

FIG. 24 is a flowchart illustrating the process 2240, shown in FIG. 22, of inferring a root cause according to an implementation. Upon START, the process 2240 analyzes telemetry data including at least one of logs, metrics, and traces (operation 2410). This operation observes any abnormal conditions in the telemetry data. Next, the process 2240 identifies a contributing factor being at least one of deployment, infrastructure, and configuration (operation 2420). Next, the process 2240 highlights a cross-domain impact (operation 2430). This cross-domain impact allows the analysis to examine the overall system. The process 2230 is then terminated.

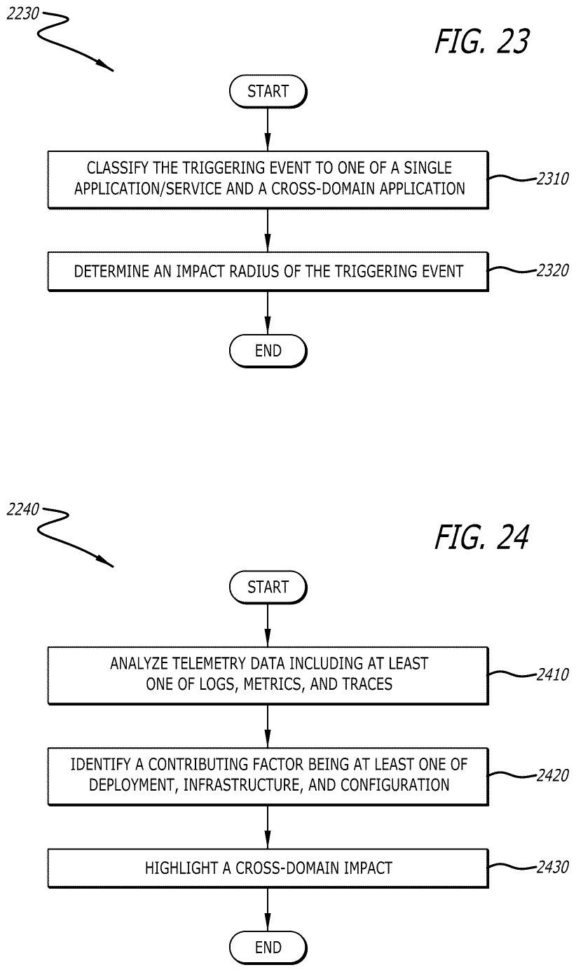

FIG. 25 is a flowchart illustrating the process 2250, shown in FIG. 22, of analyzing a historical record according to an implementation. Upon START, the process 2250 searches the historical record for past events having a similar outcome or conditions (operation 2510). Next, the process 2250 suggests a solution based on previous successful results (operation 2520). In case there are no such events, the process 2250 may be skipped. The process 2250 is then terminated.

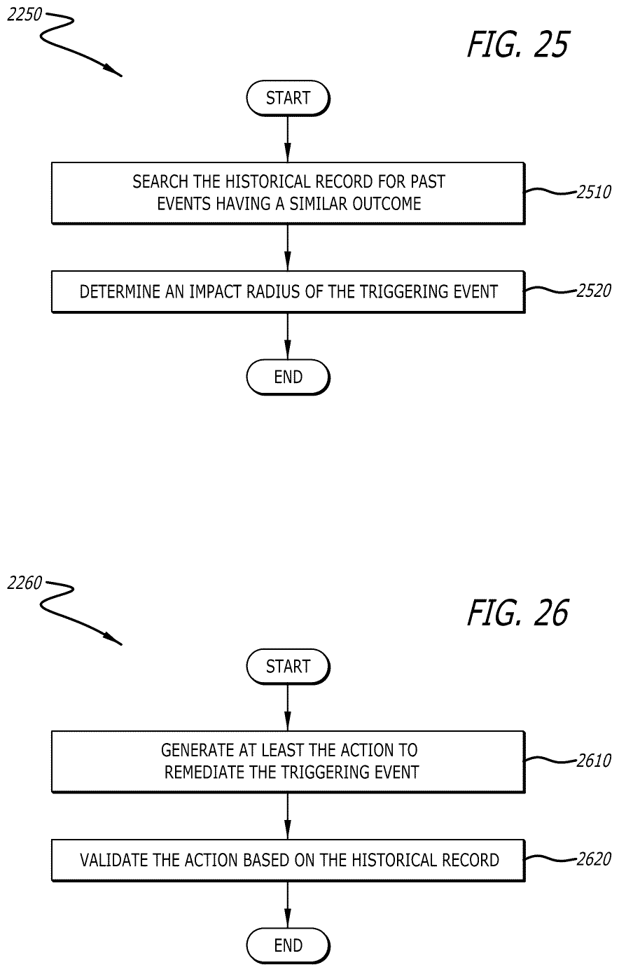

FIG. 26 is a flowchart illustrating the process 2260, shown in FIG. 22, of recommending an action according to an implementation. Upon START, the process 2260 generates at least one action to remediate the triggering event (operation 2610). The action may be a rollback, a scaling, a configuration fix or any combination of these. Next, the process 2260 validates the action based on the historical record (operation 2620). In case no such historical records exist, the operation 2620 may be skipped. The process 2260 is then terminated.

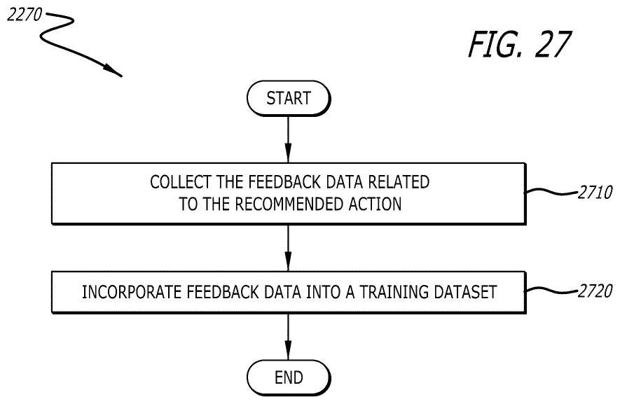

FIG. 27 is a flowchart illustrating the process 2270, shown in FIG. 22, of compiling feedback data according to an implementation. Upon START, the process 2270 collects the feedback data related to the recommended action (block 2710). This may be performed by collecting users' ratings on the recommended action, typically after the recommended action is performed and the outcome is observed and recorded. Next, the process 2270 incorporates the feedback data with the user's ratings into a training dataset for use in future training (block 2720). The training data may be used in a machine learning application or a rule-based engine. The process 2270 is then terminated.

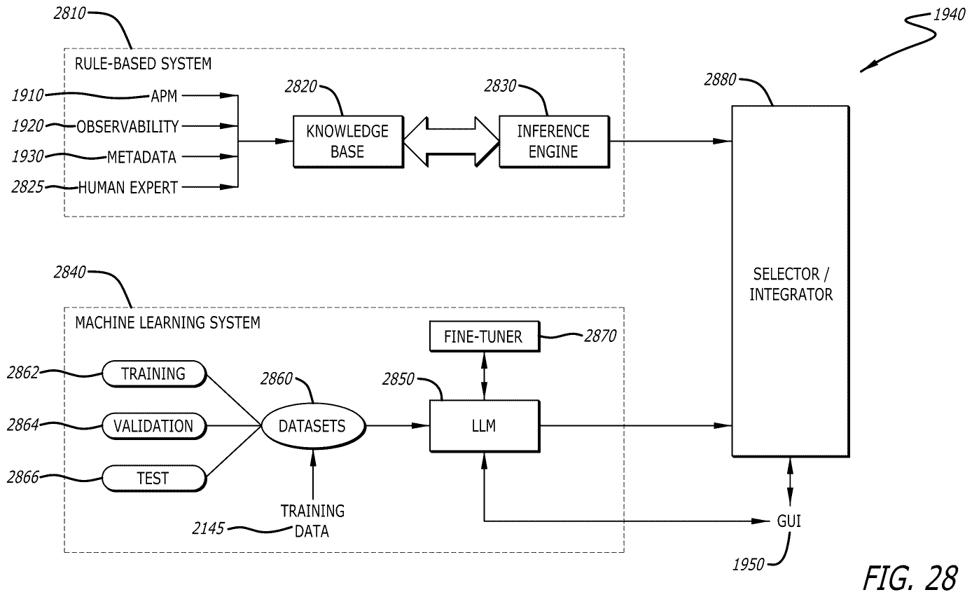

FIG. 28 is a diagram illustrating the RCA logic 1940 using a rule-based system and/or a machine learning system according to an implementation. The RCA logic 1940 includes a rule-based system 2810, a machine learning (ML) system 2840, and a selector/integrator 2880. The RCA logic 1940 nay include more or less than the above components.

The rule-based system 2810 employs a rule-based architecture to perform the RCA. It includes a knowledge base 2820 and an inference engine 2830. The rule-based system 2810 may include more or less than the above components. The knowledge base 2820 stores facts related to the system. These facts may include historical data in the historical record 2133 in FIG. 21. The rules may include rules that are designed to generate conclusions from given premises. The knowledge base 2820 may also obtain knowledge or facts from the APM tool 1910, the observability tool 1920, the metadata acquisition tool 1930, and human expert 2825. The human expert 2825 may include an experienced professional who is well versed with the technologies in the system. In one embodiment, the format of the knowledge base 2820 includes a FACT statement and a rule in an “IF. THEN” format where the IF part represents a condition and the THEN part represents an action to be taken if the condition is met. The action may include invoking another rule. A FACT statement is an assertion of something known as a fact whether it is a public or private information. An example of a rule is: “IF the pattern matches the pattern in a past incident THEN resolve by employing the solution used in that past incident.”

The inference engine 2830 is configured to infer, using a rule set, the root cause of a problem. Depending on the circumstances, the inference engine 2830 may use a forward chaining strategy that starts with known facts or backward chaining strategy that works backwards from a desired goal. An example of a forward chaining strategy is illustrated in FIG. 20.

The ML system 2840 generates a response upon receipt of an inquiry. The ML system 2840 may operate in small episodes, each episode corresponding to an operation similar to the process in FIG. 20. Alternatively, the ML system 2840 may operate from end to end, starting with an inquiry provided by the one-click button to the final response to provide the root cause and the final recommendation. The ML system 2840 includes an LLM 2850 and a fine-tuner 2870. The LLM 2850 is trained by datasets 2880. The datasets 2860 may be created by the training data 2155 shown in FIG. 21. These data include the operations such as those described in FIGS. 20-21 and the users' ratings. The datasets 2860 may be divided into a training dataset 2862, a validation dataset 2864, and a test dataset 2866 during training. The fine-tuner 2870 fine-tunes the LM 2850 by using a specific and/or narrow dataset. This may be obtained by actual occurrences of the triggering events and the user's validations.

The selector/integrator 2880 receives the results from the rule-based system 2810 and the ML system 2840 and integrates them to produce a final response to be sent to the GUI 1950. The selector/integrator 2880 may enable or disable one of the rule-based system 2810 and the ML system 2840.

The one-click RCA in this disclosure provides several technical advantages over existing techniques. These advantages include, but are not limited to, the following:
1. Provide seamless and efficient user experience in a troubleshooting experience. The RCA produces results without user's inputs. The process is automated, fast, and efficient. The operations described in FIGS. 20-21 use information or data from the existing applications such as the APM tool 1910 and the observability tool 1920.
2. The root cause analysis is accurate. By examining the entire system with a totality of observables such as logs, metrics, and traces, the one-click RCA reviews all the pertinent information related to troubleshooting. In addition, when available, the historical data provide reliable information.
3. The overall system employs existing resources and therefore requires minimal additional computing resources. The one-click RCA uses existing applications or tools without additional investment in developing capabilities. For example, the chatbot, the GUI, the APM tool 1910 and the observability tool 1920 are available.

Other advantages include: (1) flexibility because both a rule-based system and an ML system are employed, (2) fault tolerance because two AI systems complement each other and the observables and monitoring activities provide a comprehensive coverage.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

Collection and analysis of the data from a computing environment can be performed by a data intake and query system such as is described herein. A data intake and query system can ingest and store data obtained from the components in a computing environment, and can enable an entity to search, analyze, and visualize the data. Through these and other capabilities, the data intake and query system can enable an entity to use the data for administration of the computing environment, to detect security issues, to understand how the computing environment is performing or being used, and/or to perform other analytics.

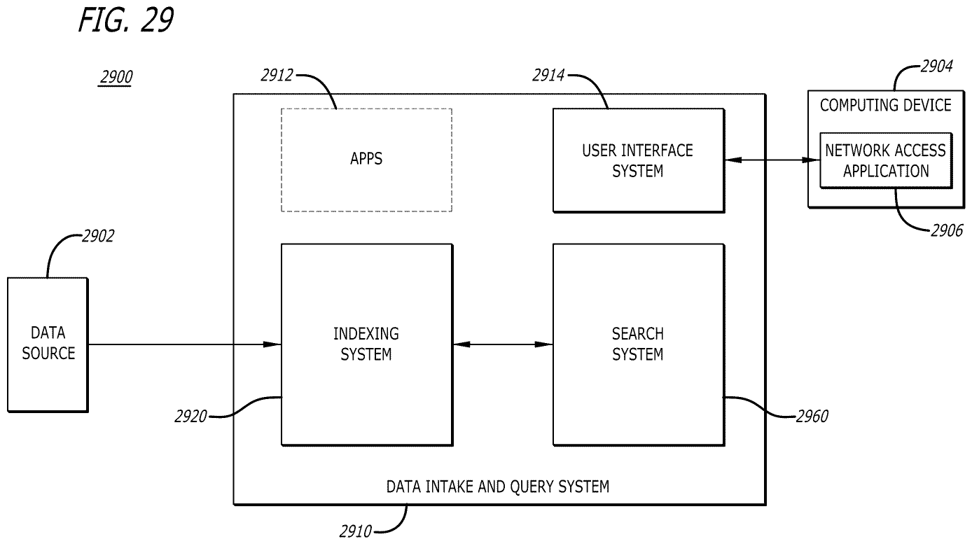

FIG. 29 is a block diagram illustrating an example computing environment 2900 that includes a data intake and query system 2910. The data intake and query system 2910 obtains data from a data source 2902 in the computing environment 2900 and ingests the data using an indexing system 2920. A search system 2960 of the data intake and query system 2910 enables users to navigate the indexed data. Though drawn with separate boxes in FIG. 29, in some implementations the indexing system 2920 and the search system 2960 can have overlapping components. A computing device 2904, running a network access application 2906, can communicate with the data intake and query system 2910 through a user interface system 2914 of the data intake and query system 2910. Using the computing device 2904, a user can perform various operations with respect to the data intake and query system 2910, such as administration of the data intake and query system 2910, management and generation of “knowledge objects,” (user-defined entities for enriching data, such as saved searches, event types, tags, field extractions, lookups, reports, alerts, data models, workflow actions, and fields), initiating of searches, and generation of reports, among other operations. The data intake and query system 2910 can further optionally include apps 2912 that extend the search, analytics, and/or visualization capabilities of the data intake and query system 2910.

The data intake and query system 2910 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 2910 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 2910 can be executed on a single computing device, or execution of the program code can be distributed over multiple computing devices. For example, the program code can include instructions for both indexing and search components (which may be part of the indexing system 2920 and/or the search system 2960, respectively), which can be executed on a computing device that also provides the data source 2902. As another example, the program code can be executed on one computing device, where execution of the program code provides both indexing and search components, while another copy of the program code executes on a second computing device that provides the data source 2902. As another example, the program code can be configured such that, when executed, the program code implements only an indexing component or only a search component. In this example, a first instance of the program code that is executing the indexing component and a second instance of the program code that is executing the search component can be executing on the same computing device or on different computing devices.

The data source 2902 of the computing environment 2900 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 2902 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 2920 obtains machine date from the data source 2902 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 2920 does not require prior knowledge of the structure of incoming data (e.g., the indexing system 2920 does not need to be provided with a schema describing the data). Additionally, the indexing system 2920 retains a copy of the data as it was received by the indexing system 2920 such that the original data is always available for searching (e.g., no data is discarded, though, in some examples, the indexing system 2920 can be configured to do so).

The search system 2960 searches the data stored by the indexing 2920 system. As discussed in greater detail below, the search system 2960 enables users associated with the computing environment 2900 (and possibly also other users) to navigate the data, generate reports, and visualize search results in “dashboards” output using a graphical interface. Using the facilities of the search system 2960, users can obtain insights about the data, such as retrieving events from an index, calculating metrics, searching for specific conditions within a rolling time window, identifying patterns in the data, and predicting future trends, among other examples. To achieve greater efficiency, the search system 2960 can apply map-reduce methods to parallelize searching of large volumes of data. Additionally, because the original data is available, the search system 2960 can apply a schema to the data at search time. This allows different structures to be applied to the same data, or for the structure to be modified if or when the content of the data changes. Application of a schema at search time may be referred to herein as a late-binding schema technique.

The user interface system 2914 provides mechanisms through which users associated with the computing environment 2900 (and possibly others) can interact with the data intake and query system 2910. These interactions can include configuration, administration, and management of the indexing system 2920, initiation and/or scheduling of queries that are to be processed by the search system 2960, receipt or reporting of search results, and/or visualization of search results. The user interface system 2914 can include, for example, facilities to provide a command line interface or a web-based interface.

Users can access the user interface system 2914 using a computing device 2904 that communicates with data intake and query system 2910, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 2900. For example, a person can log in as a particular user and, using the user's digital information, can access the data intake and query system 2910. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users' digital information, including assignment of user identifiers, management of security credentials, control of which persons are associated with which users, and so on.

The computing device 2904 can provide a human-machine interface through which a person can have a digital presence in the computing environment 2900 in the form of a user. The computing device 2904 is an electronic device having one or more processors and a memory capable of storing instructions for execution by the one or more processors. The computing device 2904 can further include input/output (I/O) hardware and a network interface. Applications executed by the computing device 2904 can include a network access application 2906, such as a web browser, which can use a network interface of the client computing device 2904 to communicate, over a network, with the user interface system 2914 of the data intake and query system 2910. The user interface system 2914 can use the network access application 2906 to generate user interfaces that enable a user to interact with the data intake and query system 2910. A web browser is one example of a network access application. A shell tool can also be used as a network access application. In some examples, the data intake and query system 2910 is an application executing on the computing device 2906. In such examples, the network access application 2906 can access the user interface system 2914 without going over a network.

The data intake and query system 2910 can optionally include apps 2912. An app of the data intake and query system 2910 is a collection of configurations, knowledge objects (a user-defined entity that enriches the data in the data intake and query system 2910), views, and dashboards that may provide additional functionality, different techniques for searching the data, and/or additional insights into the data. The data intake and query system 2910 can execute multiple applications simultaneously. Example applications include an information technology service intelligence application, which can monitor and analyze the performance and behavior of the computing environment 2900, and an enterprise security application, which can include content and searches to assist security analysts in diagnosing and acting on anomalous or malicious behavior in the computing environment 2900.

Though FIG. 29 illustrates only one data source, in practical implementations, the computing environment 2900 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 2900, the data intake and query system 2910 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 2900 can include on-prem and cloud-based computing resources, or only cloud-based resources. For example, an entity may have on-prem computing devices and a private cloud. In this example, the entity operates the data intake and query system 2910 and can choose to execute the data intake and query system 2910 on an on-prem computing device or in the cloud. In another example, a provider entity operates the data intake and query system 2910 in a public cloud and provides the functionality of the data intake and query system 2910 as a service, for example under a Software-as-a-Service (SaaS) model, to entities that pay for the user of the service on a subscription basis. In this example, the provider entity can provision a separate tenant (or possibly multiple tenants) in the public cloud network for each subscriber entity, where each tenant executes a separate and distinct instance of the data intake and query system 2910. In some implementations, the entity providing the data intake and query system 2910 is itself subscribing to the cloud services of a cloud service provider. As an example, a first entity provides computing resources under a public cloud service model, a second entity subscribes to the cloud services of the first provider entity and uses the cloud computing resources to operate the data intake and query system 2910, and a third entity can subscribe to the services of the second provider entity in order to use the functionality of the data intake and query system 2910. In this example, the data sources are associated with the third entity, users accessing the data intake and query system 2910 are associated with the third entity, and the analytics and insights provided by the data intake and query system 2910 are for purposes of the third entity's operations.

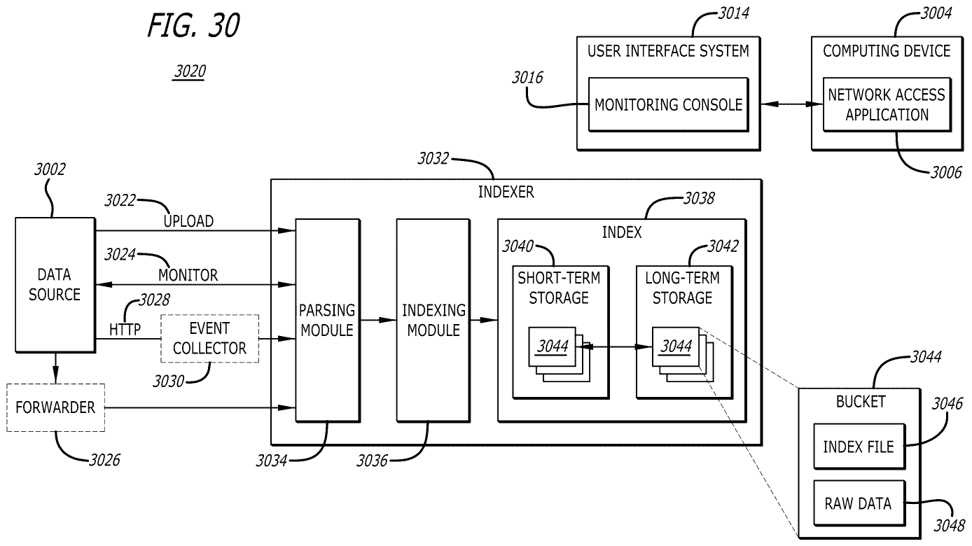

FIG. 30 is a block diagram illustrating in greater detail an example of an indexing system 3020 of a data intake and query system, such as the data intake and query system 2910 of FIG. 29. The indexing system 3020 of FIG. 30 uses various methods to obtain machine data from a data source 3002 and stores the data in an index 3038 of an indexer 3032. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 3020 enables the data intake and query system to obtain the machine data produced by the data source 3002 and to store the data for searching and retrieval.

Users can administer the operations of the indexing system 3020 using a computing device 3004 that can access the indexing system 3020 through a user interface system 3014 of the data intake and query system. For example, the computing device 3004 can be executing a network access application 3006, such as a web browser or a terminal, through which a user can access a monitoring console 3016 provided by the user interface system 3014. The monitoring console 3016 can enable operations such as: identifying the data source 3002 for data ingestion; configuring the indexer 3032 to index the data from the data source 3032; configuring a data ingestion method; configuring, deploying, and managing clusters of indexers; and viewing the topology and performance of a deployment of the data intake and query system, among other operations. The operations performed by the indexing system 3020 may be referred to as “index time” operations, which are distinct from “search time” operations that are discussed further below.

The indexer 3032, which may be referred to herein as a data indexing component, coordinates and performs most of the index time operations. The indexer 3032 can be implemented using program code that can be executed on a computing device. The program code for the indexer 3032 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 3032. In some implementations, the indexer 3032 executes on the computing device 3004 through which a user can access the indexing system 3020. In some implementations, the indexer 3032 executes on a different computing device than the illustrated computing device 3004.

The indexer 3032 may be executing on the computing device that also provides the data source 3002 or may be executing on a different computing device. In implementations wherein the indexer 3032 is on the same computing device as the data source 3002, the data produced by the data source 3002 may be referred to as “local data.” In other implementations the data source 3002 is a component of a first computing device and the indexer 3032 executes on a second computing device that is different from the first computing device. In these implementations, the data produced by the data source 3002 may be referred to as “remote data.” In some implementations, the first computing device is “on-prem” and in some implementations the first computing device is “in the cloud.” In some implementations, the indexer 3032 executes on a computing device in the cloud and the operations of the indexer 3032 are provided as a service to entities that subscribe to the services provided by the data intake and query system.

For a given data produced by the data source 3002, the indexing system 3020 can be configured to use one of several methods to ingest the data into the indexer 3032. These methods include upload 3022, monitor 3024, using a forwarder 3026, or using HyperText Transfer Protocol (HTTP 3028) and an event collector 3030. These and other methods for data ingestion may be referred to as “getting data in” (GDI) methods.

Using the upload 3022 method, a user can specify a file for uploading into the indexer 3032. For example, the monitoring console 3016 can include commands or an interface through which the user can specify where the file is located (e.g., on which computing device and/or in which directory of a file system) and the name of the file. The file may be located at the data source 3002 or maybe on the computing device where the indexer 3032 is executing. Once uploading is initiated, the indexer 3032 processes the file, as discussed further below. Uploading is a manual process and occurs when instigated by a user. For automated data ingestion, the other ingestion methods are used.

The monitor 3024 method enables the indexing system 3002 to monitor the data source 3002 and continuously or periodically obtain data produced by the data source 3002 for ingestion by the indexer 3032. For example, using the monitoring console 3016, a user can specify a file or directory for monitoring. In this example, the indexing system 3002 can execute a monitoring process that detects whenever the file or directory is modified and causes the file or directory contents to be sent to the indexer 3032. As another example, a user can specify a network port for monitoring. In this example, a monitoring process can capture data received at or transmitting from the network port and cause the data to be sent to the indexer 3032. In various examples, monitoring can also be configured for data sources such as operating system event logs, performance data generated by an operating system, operating system registries, operating system directory services, and other data sources.

Monitoring is available when the data source 3002 is local to the indexer 3032 (e.g., the data source 3002 is on the computing device where the indexer 3032 is executing). Other data ingestion methods, including forwarding and the event collector 3030, can be used for either local or remote data sources.

A forwarder 3026, which may be referred to herein as a data forwarding component, is a software process that sends data from the data source 3002 to the indexer 3032. The forwarder 3026 can be implemented using program code that can be executed on the computer device that provides the data source 3002. A user launches the program code for the forwarder 3026 on the computing device that provides the data source 3002. The user can further configure the forwarder 3026, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 3026 can provide various capabilities. For example, the forwarder 3026 can send the data unprocessed or can perform minimal processing on the data before sending the data to the indexer 3032. Minimal processing can include, for example, adding metadata tags to the data to identify a source, source type, and/or host, among other information, dividing the data into blocks, and/or applying a timestamp to the data. In some implementations, the forwarder 3026 can break the data into individual events (event generation is discussed further below) and send the events to a receiver. Other operations that the forwarder 3026 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

The event collector 3030 provides an alternate method for obtaining data from the data source 3002. The event collector 3030 enables data and application events to be sent to the indexer 3032 using HTTP 3028. The event collector 3030 can be implemented using program code that can be executing on a computing device. The program code may be a component of the data intake and query system or can be a standalone component that can be executed independently of the data intake and query system and operates in cooperation with the data intake and query system.

To use the event collector 3030, a user can, for example using the monitoring console 3016 or a similar interface provided by the user interface system 3014, enable the event collector 3030 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 3002 as an alternative method to using a username and password for authentication.

To send data to the event collector 3030, the data source 3002 is supplied with a token and can then send HTTP 3028 requests to the event collector 3030. To send HTTP 3028 requests, the data source 3002 can be configured to use an HTTP client and/or to use logging libraries such as those supplied by Java, JavaScript, and .NET libraries. An HTTP client enables the data source 3002 to send data to the event collector 3030 by supplying the data, and a Uniform Resource Identifier (URI) for the event collector 3030 to the HTTP client. The HTTP client then handles establishing a connection with the event collector 3030, transmitting a request containing the data, closing the connection, and receiving an acknowledgment if the event collector 3030 sends one. Logging libraries enable HTTP 3028 requests to the event collector 3030 to be generated directly by the data source. For example, an application can include or link a logging library, and through functionality provided by the logging library manage establishing a connection with the event collector 3030, transmitting a request, and receiving an acknowledgement.

An HTTP 3028 request to the event collector 3030 can contain a token, a channel identifier, event metadata, and/or event data. The token authenticates the request with the event collector 3030. The channel identifier, if available in the indexing system 3020, enables the event collector 3030 to segregate and keep separate data from different data sources. The event metadata can include one or more key-value pairs that describe the data source 3002 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 3030 extracts events from HTTP 3028 requests and sends the events to the indexer 3032. The event collector 3030 can further be configured to send events to one or more indexers. Extracting the events can include associating any metadata in a request with the event or events included in the request. In these implementations, event generation by the indexer 3032 (discussed further below) is bypassed, and the indexer 3032 moves the events directly to indexing. In some implementations, the event collector 3030 extracts event data from a request and outputs the event data to the indexer 3032, and the indexer generates events from the event data. In some implementations, the event collector 3030 sends an acknowledgement message to the data source 3002 to indicate that the event collector 3030 has received a particular request form the data source 3002, and/or to indicate to the data source 3002 that events in the request have been added to an index.

The indexer 3032 ingests incoming data and transforms the data into searchable knowledge in the form of events. In the data intake and query system, an event is a single piece of data that represents activity of the component represented in FIG. 30 by the data source 3002. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 3032 can include a parsing module 3034 and an indexing module 3036 for generating and storing the events. The parsing module 3034 and indexing module 3036 can be modular and pipelined, such that one component can be operating on a first set of data while the second component is simultaneously operating on a second sent of data. Additionally, the indexer 3032 may at any time have multiple instances of the parsing module 3034 and indexing module 3036, with each set of instances configured to simultaneously operate on data from the same data source or from different data sources. The parsing module 3034 and indexing module 3036 are illustrated in FIG. 30 to facilitate discussion, with the understanding that implementations with other components are possible to achieve the same functionality.

The parsing module 3034 determines information about incoming event data, where the information can be used to identify events within the event data. For example, the parsing module 3034 can associate a source type with the event data. A source type identifies the data source 3002 and describes a possible data structure of event data produced by the data source 3002. For example, the source type can indicate which fields to expect in events generated at the data source 3002 and the keys for the values in the fields, and possibly other information such as sizes of fields, an order of the fields, a field separator, and so on. The source type of the data source 3002 can be specified when the data source 3002 is configured as a source of event data. Alternatively, the parsing module 3034 can determine the source type from the event data, for example from an event field in the event data or using machine learning techniques applied to the event data.

Other information that the parsing module 3034 can determine includes timestamps. In some cases, an event includes a timestamp as a field, and the timestamp indicates a point in time when the action represented by the event occurred or was recorded by the data source 3002 as event data. In these cases, the parsing module 3034 may be able to determine from the source type associated with the event data that the timestamps can be extracted from the events themselves. In some cases, an event does not include a timestamp and the parsing module 3034 determines a timestamp for the event, for example from a name associated with the event data from the data source 3002 (e.g., a file name when the event data is in the form of a file) or a time associated with the event data (e.g., a file modification time). As another example, when the parsing module 3034 is not able to determine a timestamp from the event data, the parsing module 3034 may use the time at which it is indexing the event data. As another example, the parsing module 3034 can use a user-configured rule to determine the timestamps to associate with events.

The parsing module 3034 can further determine event boundaries. In some cases, a single line (e.g., a sequence of characters ending with a line termination) in event data represents one event while in other cases, a single line represents multiple events. In yet other cases, one event may span multiple lines within the event data. The parsing module 3034 may be able to determine event boundaries from the source type associated with the event data, for example from a data structure indicated by the source type. In some implementations, a user can configure rules the parsing module 3034 can use to identify event boundaries.

The parsing module 3034 can further extract data from events and possibly also perform transformations on the events. For example, the parsing module 3034 can extract a set of fields (key-value pairs) for each event, such as a host or hostname, source or source name, and/or source type. The parsing module 3034 may extract certain fields by default or based on a user configuration. Alternatively or additionally, the parsing module 3034 may add fields to events, such as a source type or a user-configured field. As another example of a transformation, the parsing module 3034 can anonymize fields in events to mask sensitive information, such as social security numbers or account numbers. Anonymizing fields can include changing or replacing values of specific fields. The parsing component 3034 can further perform user-configured transformations.

The parsing module 3034 outputs the results of processing incoming event data to the indexing module 3036, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 3032 can be configured to identify searchable segments that are parts of fields, searchable segments that are entire fields, or both. The parsing module 3034 organizes the searchable segments into a lexicon or dictionary for the event data, with the lexicon including each searchable segment (e.g., the field “src=10.10.1.1”) and a reference to the location of each occurrence of the searchable segment within the event data (e.g., the location within the event data of each occurrence of “src=10.10.1.1”). As discussed further below, the search system can use the lexicon, which is stored in an index file 3046, to find event data that matches a search query. In some implementations, segmentation can alternatively be performed by the forwarder 3026. Segmentation can also be disabled, in which case the indexer 3032 will not build a lexicon for the event data. When segmentation is disabled, the search system searches the event data directly.

Building index data structures generates the index 3038. The index 3038 is a storage data structure on a storage device (e.g., a disk drive or other physical device for storing digital data). The storage device may be a component of the computing device on which the indexer 3032 is operating (referred to herein as local storage) or may be a component of a different computing device (referred to herein as remote storage) that the indexer 3038 has access to over a network. The indexer 3032 can manage more than one index and can manage indexes of different types. For example, the indexer 3032 can manage event indexes, which impose minimal structure on stored data and can accommodate any type of data. As another example, the indexer 3032 can manage metrics indexes, which use a highly structured format to handle the higher volume and lower latency demands associated with metrics data.

The indexing module 3036 organizes files in the index 3038 in directories referred to as buckets. The files in a bucket 3044 can include raw data files, index files, and possibly also other metadata files. As used herein, “raw data” means data as when the data was produced by the data source 3002, without alteration to the format or content. As noted previously, the parsing component 3034 may add fields to event data and/or perform transformations on fields in the event data. Event data that has been altered in this way is referred to herein as enriched data. A raw data file 3048 can include enriched data, in addition to or instead of raw data. The raw data file 3048 may be compressed to reduce disk usage. An index file 3046, which may also be referred to herein as a “time-series index” or tsidx file, contains metadata that the indexer 3032 can use to search a corresponding raw data file 3048. As noted above, the metadata in the index file 3046 includes a lexicon of the event data, which associates each unique keyword in the event data with a reference to the location of event data within the raw data file 3048. The keyword data in the index file 3046 may also be referred to as an inverted index. In various implementations, the data intake and query system can use index files for other purposes, such as to store data summarizations that can be used to accelerate searches.

A bucket 3044 includes event data for a particular range of time. The indexing module 3036 arranges buckets in the index 3038 according to the age of the buckets, such that buckets for more recent ranges of time are stored in short-term storage 3040 and buckets for less recent ranges of time are stored in long-term storage 3042. Short-term storage 3040 may be faster to access while long-term storage 3042 may be slower to access. Buckets may be moves from short-term storage 3040 to long-term storage 3042 according to a configurable data retention policy, which can indicate at what point in time a bucket is old enough to be moved.

A bucket's location in short-term storage 3040 or long-term storage 3042 can also be indicated by the bucket's status. As an example, a bucket's status can be “hot,” “warm,” “cold,” “frozen,” or “thawed.” In this example, hot bucket is one to which the indexer 3032 is writing data and the bucket becomes a warm bucket when the index 3032 stops writing data to it. In this example, both hot and warm buckets reside in short-term storage 3040. Continuing this example, when a warm bucket is moved to long-term storage 3042, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 3020 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each buckets must exist within the cluster), and indexers to which buckets are copied may be selected to optimize distribution of data across the cluster.

A user can view the performance of the indexing system 3020 through the monitoring console 3016 provided by the user interface system 3014. Using the monitoring console 3016, the user can configure and monitor an index cluster, and see information such as disk usage by an index, volume usage by an indexer, index and volume size over time, data age, statistics for bucket types, and bucket settings, among other information.

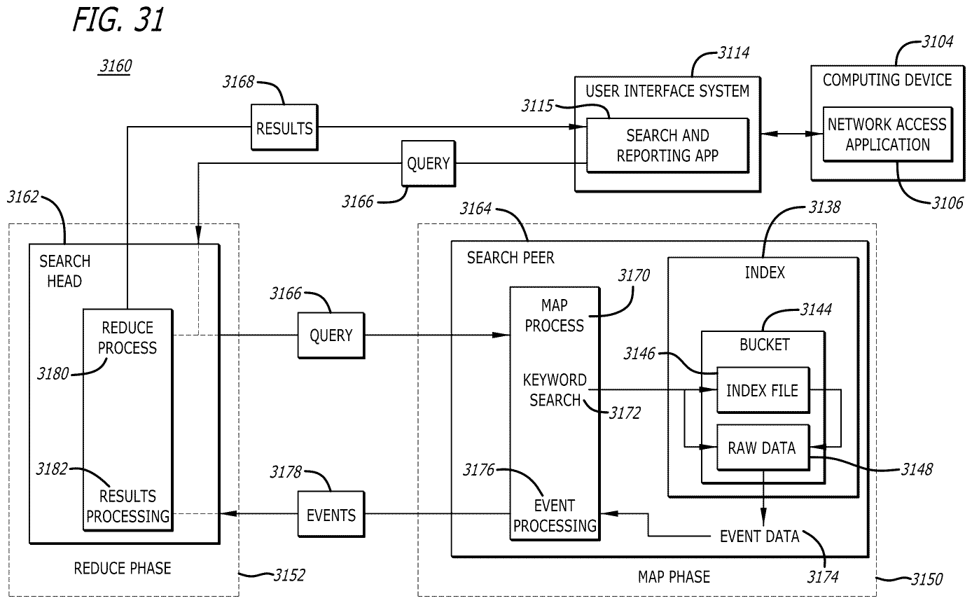

FIG. 31 is a block diagram illustrating in greater detail an example of the search system 3160 of a data intake and query system, such as the data intake and query system 2910 of FIG. 29. The search system 3160 of FIG. 31 issues a query 3166 to a search head 3162, which sends the query 3166 to a search peer 3164. Using a map process 3170, the search peer 3164 searches the appropriate index 3138 for events identified by the query 3166 and sends events 3178 so identified back to the search head 3162. Using a reduce process 3182, the search head 3162 processes the events 3178 and produces results 3168 to respond to the query 3166. The results 3168 can provide useful insights about the data stored in the index 3138. These insights can aid in the administration of information technology systems, in security analysis of information technology systems, and/or in analysis of the development environment provided by information technology systems.

The query 3166 that initiates a search is produced by a search and reporting app 3116 that is available through the user interface system 3114 of the data intake and query system. Using a network access application 3106 executing on a computing device 3104, a user can input the query 3166 into a search field provided by the search and reporting app 3116. Alternatively or additionally, the search and reporting app 3116 can include pre-configured queries or stored queries that can be activated by the user. In some cases, the search and reporting app 3116 initiates the query 3166 when the user enters the query 3166. In these cases, the query 3166 maybe referred to as an “ad-hoc” query. In some cases, the search and reporting app 3116 initiates the query 3166 based on a schedule. For example, the search and reporting app 3116 can be configured to execute the query 3166 once per hour, once per day, at a specific time, on a specific date, or at some other time that can be specified by a date, time, and/or frequency. These types of queries maybe referred to as scheduled queries.

The query 3166 is specified using a search processing language. The search processing language includes commands or search terms that the search peer 3164 will use to identify events to return in the search results 3168. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 3166 to include sequential commands, where a subsequent command may operate on the results of a prior command. As an example, sequential commands may be separated in the query 3166 by a vertical line (“|” or “pipe”) symbol.

In addition to one or more search commands, the query 3166 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 3166 occurs in two broad phases: a map phase 3150 and a reduce phase 3152. The map phase 3150 takes place across one or more search peers. In the map phase 3150, the search peers locate event data that matches the search terms in the search query 3166 and sorts the event data into field-value pairs. When the map phase 3150 is complete, the search peers send events that they have found to one or more search heads for the reduce phase 3152. During the reduce phase 3152, the search heads process the events through commands in the search query 3166 and aggregate the events to produce the final search results 3168.

A search head, such as the search head 3162 illustrated in FIG. 31, is a component of the search system 3160 that manages searches. The search head 3162, which may also be referred to herein as a search management component, can be implemented using program code that can be executed on a computing device. The program code for the search head 3162 can be stored on a non-transitory computer-readable medium and from this medium can be loaded or copied to the memory of a computing device. One or more hardware processors of the computing device can read the program code from the memory and execute the program code in order to implement the operations of the search head 3162.

Upon receiving the search query 3166, the search head 3162 directs the query 3166 to one or more search peers, such as the search peer 3164 illustrated in FIG. 31. “Search peer” is an alternate name for “indexer” and a search peer may be largely similar to the indexer described previously. The search peer 3164 may be referred to as a “peer node” when the search peer 3164 is part of an indexer cluster. The search peer 3164, which may also be referred to as a search execution component, can be implemented using program code that can be executed on a computing device. In some implementations, one set of program code implements both the search head 3162 and the search peer 3164 such that the search head 3162 and the search peer 3164 form one component. In some implementations, the search head 3162 is an independent piece of code that performs searching and no indexing functionality. In these implementations, the search head 3162 may be referred to as a dedicated search head.

The search head 3162 may consider multiple criteria when determining whether to send the query 3166 to the particular search peer 3164. For example, the search system 3160 may be configured to include multiple search peers that each have duplicative copies of at least some of the event data and are implanted using different hardware resources q. In this example, the sending the search query 3166 to more than one search peer allows the search system 3160 to distribute the search workload across different hardware resources. As another example, search system 3160 may include different search peers for different purposes (e.g., one has an index storing a first type of data or from a first data source while a second has an index storing a second type of data or from a second data source). In this example, the search query 3166 may specify which indexes to search, and the search head 3162 will send the query 3166 to the search peers that have those indexes.

To identify events 3178 to send back to the search head 3162, the search peer 3164 performs a map process 3170 to obtain event data 3174 from the index 3138 that is maintained by the search peer 3164. During a first phase of the map process 3170, the search peer 3164 identifies buckets that have events that are described by the time indicator in the search query 3166. As noted above, a bucket contains events whose timestamps fall within a particular range of time. For each bucket 3144 whose events can be described by the time indicator, during a second phase of the map process 3170, the search peer 3164 performs a keyword search 3174 using search terms specified in the search query 3166. The search terms can be one or more of keywords, phrases, fields, Boolean expressions, and/or comparison expressions that in combination describe events being searched for. When segmentation is enabled at index time, the search peer 3164 performs the keyword search 3172 on the bucket's index file 3146. As noted previously, the index file 3146 includes a lexicon of the searchable terms in the events stored in the bucket's raw data 3148 file. The keyword search 3172 searches the lexicon for searchable terms that correspond to one or more of the search terms in the query 3166. As also noted above, the lexicon incudes, for each searchable term, a reference to each location in the raw data 3148 file where the searchable term can be found. Thus, when the keyword search identifies a searchable term in the index file 3146 that matches a search term in the query 3166, the search peer 3164 can use the location references to extract from the raw data 3148 file the event data 3174 for each event that include the searchable term.

In cases where segmentation was disabled at index time, the search peer 3164 performs the keyword search 3172 directly on the raw data 3148 file. To search the raw data 3148, the search peer 3164 may identify searchable segments in events in a similar manner as when the data was indexed. Thus, depending on how the search peer 3164 is configured, the search peer 3164 may look at event fields and/or parts of event fields to determine whether an event matches the query 3166. Any matching events can be added to the event data 3174 read from the raw data 3148 file. The search peer 3164 can further be configured to enable segmentation at search time, so that searching of the index 3138 causes the search peer 3164 to build a lexicon in the index file 3146.

The event data 3174 obtained from the raw data 3148 file includes the full text of each event found by the keyword search 3172. During a third phase of the map process 3170, the search peer 3164 performs event processing 3176 on the event data 3174, with the steps performed being determined by the configuration of the search peer 3164 and/or commands in the search query 3166. For example, the search peer 3164 can be configured to perform field discovery and field extraction. Field discovery is a process by which the search peer 3164 identifies and extracts key-value pairs from the events in the event data 3174. The search peer 3164 can, for example, be configured to automatically extract the first 100 fields (or another number of fields) in the event data 3174 that can be identified as key-value pairs. As another example, the search peer 3164 can extract any fields explicitly mentioned in the search query 3166. The search peer 3164 can, alternatively or additionally, be configured with particular field extractions to perform.

Other examples of steps that can be performed during event processing 3176 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 3164 sends processed events 3178 to the search head 3162, which performs a reduce process 3180. The reduce process 3180 potentially receives events from multiple search peers and performs various results processing 3182 steps on the received events. The results processing 3182 steps can include, for example, aggregating the events received from different search peers into a single set of events, deduplicating and aggregating fields discovered by different search peers, counting the number of events found, and sorting the events by timestamp (e.g., newest first or oldest first), among other examples. Results processing 3182 can further include applying commands from the search query 3166 to the events. The query 3166 can include, for example, commands for evaluating and/or manipulating fields (e.g., to generate new fields from existing fields or parse fields that have more than one value). As another example, the query 3166 can include commands for calculating statistics over the events, such as counts of the occurrences of fields, or sums, averages, ranges, and so on, of field values. As another example, the query 3166 can include commands for generating statistical values for purposes of generating charts of graphs of the events.

The reduce process 3180 outputs the events found by the search query 3166, as well as information about the events. The search head 3162 transmits the events and the information about the events as search results 3168, which are received by the search and reporting app 3116. The search and reporting app 3116 can generate visual interfaces for viewing the search results 3168. The search and reporting app 3116 can, for example, output visual interfaces for the network access application 3106 running on a computing device 3104 to generate.

The visual interfaces can include various visualizations of the search results 3168, such as tables, line or area charts, Choropleth maps, or single values. The search and reporting app 3116 can organize the visualizations into a dashboard, where the dashboard includes a panel for each visualization. A dashboard can thus include, for example, a panel listing the raw event data for the events in the search results 3168, a panel listing fields extracted at index time and/or found through field discovery along with statistics for those fields, and/or a timeline chart indicating how many events occurred at specific points in time (as indicated by the timestamps associated with each event). In various implementations, the search and reporting app 3116 can provide one or more default dashboards. Alternatively or additionally, the search and reporting app 3116 can include functionality that enables a user to configure custom dashboards.

The search and reporting app 3116 can also enable further investigation into the events in the search results 3116. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 3166. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

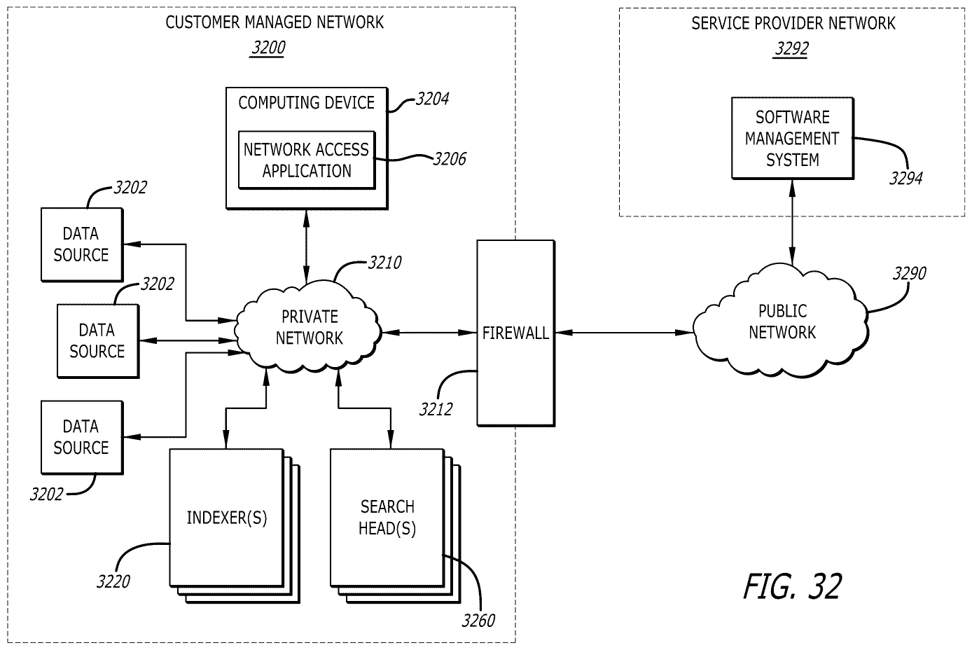

FIG. 32 illustrates an example of a self-managed network 3200 that includes a data intake and query system. “Self-managed” in this instance means that the entity that is operating the self-managed network 3200 configures, administers, maintains, and/or operates the data intake and query system using its own compute resources and people. Further, the self-managed network 3200 of this example is part of the entity's on-premise network and comprises a set of compute, memory, and networking resources that are located, for example, within the confines of a entity's data center. These resources can include software and hardware resources. The entity can, for example, be a company or enterprise, a school, government entity, or other entity. Since the self-managed network 3200 is located within the customer's on-prem environment, such as in the entity's data center, the operation and management of the self-managed network 3200, including of the resources in the self-managed network 3200, is under the control of the entity. For example, administrative personnel of the entity have complete access to and control over the configuration, management, and security of the self-managed network 3200 and its resources.

The self-managed network 3200 can execute one or more instances of the data intake and query system. An instance of the data intake and query system may be executed by one or more computing devices that are part of the self-managed network 3200. A data intake and query system instance can comprise an indexing system and a search system, where the indexing system includes one or more indexers 3220 and the search system includes one or more search heads 3260.

As depicted in FIG. 32, the self-managed network 3200 can include one or more data sources 3202. Data received from these data sources may be processed by an instance of the data intake and query system within self-managed network 3200. The data sources 3202 and the data intake and query system instance can be communicatively coupled to each other via a private network 3210.

Users associated with the entity can interact with and avail themselves of the functions performed by a data intake and query system instance using computing devices.

As depicted in FIG. 32, a computing device 3204 can execute a network access application 3206 (e.g., a web browser), that can communicate with the data intake and query system instance and with data sources 3202 via the private network 3210. Using the computing device 3204, a user can perform various operations with respect to the data intake and query system, such as management and administration of the data intake and query system, generation of knowledge objects, and other functions. Results generated from processing performed by the data intake and query system instance may be communicated to the computing device 3204 and output to the user via an output system (e.g., a screen) of the computing device 3204.

The self-managed network 3200 can also be connected to other networks that are outside the entity's on-premise environment/network, such as networks outside the entity's data center. Connectivity to these other external networks is controlled and regulated through one or more layers of security provided by the self-managed network 3200. One or more of these security layers can be implemented using firewalls 3212. The firewalls 3212 form a layer of security around the self-managed network 3200 and regulate the transmission of traffic from the self-managed network 3200 to the other networks and from these other networks to the self-managed network 3200.

Networks external to the self-managed network can include various types of networks including public networks 3290, other private networks, and/or cloud networks provided by one or more cloud service providers. An example of a public network 3290 is the Internet. In the example depicted in FIG. 32, the self-managed network 3200 is connected to a service provider network 3292 provided by a cloud service provider via the public network 3290.

In some implementations, resources provided by a cloud service provider may be used to facilitate the configuration and management of resources within the self-managed network 3200. For example, configuration and management of a data intake and query system instance in the self-managed network 3200 may be facilitated by a software management system 3294 operating in the service provider network 3292. There are various ways in which the software management system 3294 can facilitate the configuration and management of a data intake and query system instance within the self-managed network 3200. As one example, the software management system 3294 may facilitate the download of software including software updates for the data intake and query system. In this example, the software management system 3294 may store information indicative of the versions of the various data intake and query system instances present in the self-managed network 3200. When a software patch or upgrade is available for an instance, the software management system 3294 may inform the self-managed network 3200 of the patch or upgrade. This can be done via messages communicated from the software management system 3294 to the self-managed network 3200.

The software management system 3294 may also provide simplified ways for the patches and/or upgrades to be downloaded and applied to the self-managed network 3200. For example, a message communicated from the software management system 3294 to the self-managed network 3200 regarding a software upgrade may include a Uniform Resource Identifier (URI) that can be used by a system administrator of the self-managed network 3200 to download the upgrade to the self-managed network 3200. In this manner, management resources provided by a cloud service provider using the service provider network 3292 and which are located outside the self-managed network 3200 can be used to facilitate the configuration and management of one or more resources within the entity's on-prem environment. In some implementations, the download of the upgrades and patches may be automated, whereby the software management system 3294 is authorized to, upon determining that a patch is applicable to a data intake and query system instance inside the self-managed network 3200, automatically communicate the upgrade or patch to self-managed network 3200 and cause it to be installed within self-managed network 3200.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to perform a computer-implemented method such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A computer-implemented method, comprising:
receiving a user input via a graphical user interface (GUI) requesting automated performance of a root cause analysis corresponding to an alert due to a triggering event, wherein the triggering event is associated with a time-series data set;
performing pre-processing on the time-series data set;
generating a prompt instructing a large language model (LLM) to perform the root cause analysis based on results of the pre-processing on the time-series data set;
transmitting the prompt to the LLM;
receiving a response to the prompt from the LLM including results of the root cause analysis; and
revising the GUI resulting in display of the results of the root cause analysis.

2. The computer-implemented method of claim 1, wherein the pre-processing includes performing one or more anomaly detection methodologies on the time-series data set resulting in detection of an anomaly associated with a timestamp.

3. The computer-implemented method of claim 2, wherein the pre-processing further includes determining an anomaly time window associated with the anomaly based on the timestamp.

4. The computer-implemented method of claim 3, wherein the pre-processing further includes retrieving one or more of traces or logs generated in or by a networking environment of a user and within the anomaly time window, wherein the user provided the user input.

5. The computer-implemented method of claim 1, wherein the LLM is an orchestration agent and a component of an artificial intelligence (AI) assistant that also includes one or more sub-LLMs and one or more logic modules.

6. The computer-implemented method of claim 5, wherein the orchestration agent is configured to parse the prompt, determine a plan for answering the prompt, invoke a first sub-LLM of the one or more sub-LLMs or a first logic module of the one or more logic modules, and reason with results provided by the first sub-LLM or the first logic module.

7. The computer-implemented method of claim 1, wherein the prompt provides instructions to perform the root cause analysis on the triggering event and includes a portion of the time-series data set or one or more traces or logs associated with the time-series data set.

8. A computing device, comprising:
a processor; and
a non-transitory computer-readable medium having stored thereon instructions that, when executed by the processor, cause the processor to perform operations including:
receiving a user input via a graphical user interface (GUI) requesting automated performance of a root cause analysis corresponding to an alert due to a triggering event, wherein the triggering event is associated with a time-series data set;
performing pre-processing on the time-series data set,
generating a prompt instructing a large language model (LLM) to perform the root cause analysis based on results of the pre-processing on the time-series data set;
transmitting the prompt to the LLM,
receiving a response to the prompt from the LLM including results of the root cause analysis, and
revising the GUI resulting in display of the results of the root cause analysis.

9. The computing device of claim 8, wherein the pre-processing includes performing one or more anomaly detection methodologies on the time-series data set resulting in detection of an anomaly associated with a timestamp.

10. The computing device of claim 9, wherein the pre-processing further includes determining an anomaly time window associated with the anomaly based on the timestamp.

11. The computing device of claim 10, wherein the pre-processing further includes retrieving one or more of traces or logs generated in or by a networking environment of a user and within the anomaly time window, wherein the user provided the user input.

12. The computing device of claim 8, wherein the LLM is an orchestration agent and a component of an artificial intelligence (AI) assistant that also includes one or more sub-LLMs and one or more logic modules.

13. The computing device of claim 12, wherein the orchestration agent is configured to parse the prompt, determine a plan for answering the prompt, invoke a first sub-LLM of the one or more sub-LLMs or a first logic module of the one or more logic modules, and reason with results provided by the first sub-LLM or the first logic module.

14. The computing device of claim 8, wherein the prompt provides instructions to perform the root cause analysis on the triggering event and includes a portion of the time-series data set or one or more traces or logs associated with the time-series data set.

15. A non-transitory computer-readable medium having stored thereon instructions that, when executed by one or more processors, cause the one or more processors to perform operations including:
receiving a user input via a graphical user interface (GUI) requesting automated performance of a root cause analysis corresponding to an alert due to a triggering event, wherein the triggering event is associated with a time-series data set;
performing pre-processing on the time-series data set;
generating a prompt instructing a large language model (LLM) to perform the root cause analysis based on results of the pre-processing on the time-series data set;
transmitting the prompt to the LLM;
receiving a response to the prompt from the LLM including results of the root cause analysis; and
revising the GUI resulting in display of the results of the root cause analysis.

16. The non-transitory computer-readable medium of claim 15, wherein the pre-processing includes performing one or more anomaly detection methodologies on the time-series data set resulting in detection of an anomaly associated with a timestamp.

17. The non-transitory computer-readable medium of claim 16, wherein the pre-processing further includes determining an anomaly time window associated with the anomaly based on the timestamp.

18. The non-transitory computer-readable medium of claim 17, wherein the pre-processing further includes retrieving one or more of traces or logs generated in or by a networking environment of a user and within the anomaly time window, wherein the user provided the user input.

19. The non-transitory computer-readable medium of claim 15, wherein the LLM is an orchestration agent and a component of an artificial intelligence (AI) assistant that also includes one or more sub-LLMs and one or more logic modules, wherein the orchestration agent is configured to parse the prompt, determine a plan for answering the prompt, invoke a first sub-LLM of the one or more sub-LLMs or a first logic module of the one or more logic modules, and reason with results provided by the first sub-LLM or the first logic module.

20. The non-transitory computer-readable medium of claim 15, wherein the prompt provides instructions to perform the root cause analysis on the triggering event and includes a portion of the time-series data set or one or more traces or logs associated with the time-series data set.
